(19) United States
(12) Patent Application Publication
(10) Pub. No.: US 2026/0233515 A1
(43) Pub. Date: Aug. 13, 2026

(54) METHOD, APPARATUS AND CIRCUIT FOR TRIMMING DROPLET EJECTION SIGNALS

(71) Applicant: XAAR TECHNOLOGY LIMITED, Huntingdon, Cambridgeshire (GB)

(72) Inventors: Nicholas STAPLETON, Huntingdon, Cambridgeshire (GB); Michael REDDISH, Huntingdon, Cambridgeshire (GB); David CAPON, Huntingdon, Cambridgeshire (GB)

(21) Appl. No.: 19/164,194

(22) PCT Filed: Mar. 13, 2024
(86) PCT No.: PCT/GB2024/050678

§ 371 Date: Sep. 10, 2025

(30) Foreign Application Priority Data
Mar. 14, 2023 (GB) 2303735.1

(51) Int. Cl. B41J 2/045

(52) U.S. Cl. CPC B41J 2/04588; B41J 2/04541; B41J 2/0455; B41J 2/04573; B41J 2/04581; B41J 2/04596

(57) ABSTRACT

Circuits, systems and methods for reducing heat generation at a printhead are disclosed. Inputs are provided for receiving at least two common drive waveforms (411, 412) and a trimming signal (321). An output is also provided for supplying an individual drive waveform to an actuator. A waveform select (330) is configured to couple to the common drive waveforms and to the output for connection to a first electrode of the actuator. The waveform select is configured to provide the individual drive waveform to a selected one of the actuators based on the first common drive waveform, the second common drive waveform and the trimming signal by causing a transition from the first common drive waveform to the second common drive waveform at a time determined by the trimming signal.

### FIELD OF THE INVENTION

The present application relates to a droplet ejection apparatus and methods for controlling ejection of fluid droplets in a consistent manner. In particular, the systems and methods set out herein are directed to efficiently implementing these goals while limiting heat generation in the droplet ejection apparatus.

### BACKGROUND

Droplet ejection apparatus comprising at least one droplet ejection head, are now in widespread usage, whether in more traditional applications, such as inkjet printing, or in materials deposition applications, such as 3D printing and other rapid prototyping techniques, and the printing of raised patterns on surfaces, e.g. braille or decorative raised patterns. In such materials deposition applications, it may be desired to deposit a relatively large amount of fluid on a medium using droplet ejection heads. In some cases, the fluids may have novel chemical properties to adhere to new mediums and increase the functionality of the deposited material.

Recently, droplet ejection heads have been developed that are capable of depositing inks and varnishes directly onto ceramic tiles, with high reliability and throughput. This allows the patterns on the tiles to be customized to a customer's exact specifications, as well as reducing the need for a full range of tiles to be kept in stock.

In still other applications, droplet ejection heads may be used to form elements such as colour filters in LCD or OLED displays, e.g. as used in flat-screen television manufacturing.

It will therefore be appreciated that droplet ejection heads continue to evolve and specialise so as to be suitable for new and/or increasingly challenging deposition applications. Nonetheless, while a great many developments have been made in the field of droplet ejection heads, there remains room for improvements in the field of droplet ejection heads.

In particular, droplet ejection heads usually comprise an array of fluid chambers having electrically actuable walls, each fluid chamber being actuable to selectively eject a droplet. Usually, this droplet ejection is achieved by forming at least one actuator wall of a fluid chamber from a piezoelectric material, and then using electrodes to move the actuator wall(s) of a fluid chamber to alter the volume.

However, the response of each fluid chamber to a given control signal is not always the same. The performance of each piezoelectric actuator may be affected by one or more of:
manufacturing tolerances of the fluid chamber, e.g. variations in shape and/or size of the fluid chambers;
different types of crosstalk from actuators in close proximity, e.g. electrical, fluidic, mechanical etc.;
printing frequency;
ambient temperature and/or fluid temperature, which may cause the fluid to change a number of its properties, for example viscosity, which in turn, affect the volume and/or speed of the ejected droplets;
time elapsed since the actuator last ejected a droplet, which may lead to non-uniform droplet characteristics due to the variation in accumulated energy in each fluid chamber;
how long the fluid chamber has been in use, for example because the fluid chamber may degrade with repeated use.

These variations influence the droplet velocity/volume and shape, causing errors and artefacts in the image quality during printing. These variations between two actuators can be mitigated by implementing a trimming mechanism that allows to adjust the drop velocity or volume per-actuator and allows the printing system to individually control the actuators. When implemented correctly, this leads to uniform droplet ejection.

In order to supply drive signals to droplet ejection head, there are two fundamental approaches, described herein as a hot switch method and a cold switch method.

The hot switch method is so-called because the drive waveforms are generated within the droplet ejection head causing the droplet ejection head to heat up due to the power dissipated by the integrated circuits that generate the drive waveforms and the power dissipation increases as the print speed increases. In hot switch method, generation of individual drive waveforms for each actuator is easy to achieve because the waveforms are generated within the droplet ejection head and can be easily tailored to the individual actuator. It is, however, much more difficult to cool-off the integrated circuit and keep it at or around its operating temperature. Further, it would be advantageous to reduce heat dissipation in the head.

In the cold switch method, a common drive waveform (CDW) is generated outside the droplet ejection head and the electronics inside the head merely connect the CDW to the appropriate actuator. By this means most of the power dissipated during the generation of the waveform is dissipated in the drive circuit, which is outside the droplet ejection head and, therefore, it is easier to keep the electronics inside the droplet ejection head cool and keep it at or around its operating temperature. In the cold switch method, the provision of individual drive waveforms is limited as there is only a single common drive waveform available and all the actuators are presented with that waveform for printing or no waveform if not printing. No variation of the individual drive waveform in order to tailor it to the individual actuator is possible in this context.

One method for providing the trimming mechanism is based on changing the amplitude of the common drive waveform according to the required trimming because the droplet velocity and volume are a function of the waveform amplitude and applying tailored waveform to the individual actuators. However, performing “voltage trimming” in a simple cold switch environment is not feasible because there is a single common drive waveform hence its amplitude is already fixed. Other trimming solutions can be found that allow some modification of the waveform that appears at each nozzle. Typically, they might use one or more variations of the CDW and allow modification of the waveform that appears at each nozzle by switching between the CDW and one or more of its variants at different points during the waveform. However, this could cause increase in the power consumption of integrated circuit, losing some of the thermal advantages of the cold switching.

The present invention is directed towards solving some or all of the problems identified above.

### SUMMARY OF INVENTION

Aspects of the present invention are set out in the appended independent claims, while particular embodiments of the invention are set out in the appended dependent claims.

Accordingly, disclosed herein is a circuit for controlling a plurality of actuators, each actuator associated with at least one fluid chamber in a droplet ejection apparatus, the circuit comprising: inputs for receiving a first common drive waveform, a second common drive waveform, and a trimming signal; an output for supplying an individual drive waveform to an actuator; and a waveform select configured to couple to the first common drive waveform and to the output for connection to a first electrode of the actuator; the waveform select is configured to provide the drive waveform to a selected one of the actuators based on the first common drive waveform, the second common drive waveform and the trimming signal; wherein the waveform select is further configured to, cause a transition from the first common drive waveform to the second common drive waveform by decoupling the first common drive waveform from the output and coupling the second drive common waveform to the output, the transition occurring at a time determined by the trimming signal.

The express use of two different common drive waveforms with a transition between them, which can be used to provide various trimming effects, including those having shapes such as shown in the Figures. There are several general shapes which may be used in this context. A first shape is to peak at a first high (large magnitude, i.e. positive or negative) value before dropping back to a lower (smaller magnitude, still positive if the large magnitude was positive, negative if the large magnitude was negative) after a certain time (controlled by the trimming signal) to form a plateau or shoulder in the plot of voltage against time. Other general shapes may include increasing to first, lower magnitude and holding there for a period of time before increasing to a larger magnitude for a further period of time. Whichever of these shapes is employed, this approach allows for the location of heat generation to be moved away from the droplet ejection head and in particular allows for as little as possible of the heat to be generated on the head by shifting the complexity of producing the two common drive waveforms off-head. The only chamber-specific transition which occurs on-head is a switch between the two common drive waveforms at a time determined by the trimming signal.

A common drive waveform in this context is one which is supplied to or available to a plurality of (in some cases all) actuators. Note that since each actuator bases the output on the same common drive waveforms, the supply of input signals to the droplet ejection head is simple and is synchronised for all actuators (since each actuator receives the same basis signals from which a bespoke drive waveform is constructed for each actuator).

Optionally, the waveform select is further configured to receive different trimming signals supplied to the inputs, to thereby generate a transition between the common drive waveforms at different times such that, different individual drive waveforms are supplied to different outputs for different actuators in the droplet ejection apparatus. This may provide a simple way for different actuators, depending on a compensation requirement, (such as to account for differences in geometry between different chambers and other inhomogeneities set out below in more detail) to receive different signals. In other words, by providing a bespoke trimming signal to the circuitry may result in a transition between the two common drive waveforms at a time which is bespoke for each actuator.

Optionally, the waveform select is configured to receive a bespoke trimming signal for each actuator associated with each output to cause a transition between common drive waveforms at a time specific to each actuator. In this context, bespoke does not necessarily mean all trimming signals cause transitions at different times, just that the compensation requirement allows a timing for each actuator to be selected based on the properties of each actuator/fluid chamber in order to mitigate the variation caused in the droplet ejection properties due to the difference in the actuator/fluid chamber properties. Therefore, in general, the trimming signals can all be different and may well be in a given example, but in some cases different fluid chambers may have the manufacturing parameters leading to the same droplet ejection properties, and thereby those fluid chambers may receive the same trimming signal and/or have the same trimmed drive waveform supplied to them. Further, note that trimming signal may be zero for the fluid chambers/actuators which do not require the compensation. It should be noted that terms “individual drive waveform” and “trimmed drive waveform” are used interchangeably in this document.

Optionally, the trimming signal for the or each actuator is derived empirically. For example, the specific properties of the fluid chamber and/or the actuator may be measured to determine the trimming signal which best mitigates the properties and results in each fluid chamber tending towards the same ejection properties. In some cases, the ejection properties may be adjusted in this way to match the ejection properties of a particular fluid chamber, while in other cases the ejection properties of each fluid chamber may be adjusted to match with a desired or predetermined set of ejection properties. Properties of the fluid chamber may include, for example, thickness of the actuator, material from which the actuator is formed, volume of the fluid chamber, dimensions of the fluid chamber, location of the actuator (for example, roof mode or shared wall etc.). Empirical derivations of this kind may include, for example, printing with a particular trimming value, reviewing the output (manually or with machine assistance), adjusting the trimming value, and repeating the process with new trimming values until the printed output is as desired. Trimming signals may also be used to mitigate the disturbances in the fluid caused by the movement of a given fluid chamber or of its neighbouring fluid chambers in case of high speed printing.

Optionally, the trimming signal is updated iteratively. This may involve for example, regularly/periodically assessing whether the trimming value is still optimal for one or more fluid chambers. As a non-limiting example, the assessment may be made according to:
a fixed schedule (e.g. every day, week, month, etc.); on detection of specific printing errors (whether by a human or machine), which may lead to a diagnostic procedure being run of which the recalibration of the trimming is part;
every time the apparatus is powered down and restarted, or is simply inactive for at least a predetermined period of time;
on detection of a change in temperature, for example a change of more than a threshold temperature for at least a certain amount of time;
detection that the apparatus has moved to a new location;
the type of fluid (having different properties such as viscosity) which is to be ejected from the fluid chambers;
the type of print media,
changes in print mode (for changes between the number of droplets deposited per dot—between 1 droplet per dot (dpd) and multi dpd printing)
continuous monitoring of print quality, or of other related parameters such as temperature, fully/partially blocked nozzles, etc. and enacting adjustments to the trimming signal on the fly.

In some cases, trimming values may be set at a factory value (or calibrated in the factory) and a calibration routine as part of the initial or periodic set up may be enacted after the droplet ejection head has been installed in the droplet ejection apparatus or when the droplet ejection apparatus becomes aware of changes in the ejection system. For example, the droplet ejection apparatus may become aware of changes in one or more of the parameters of the assessment discussed above.

The common drive waveform may comprise a plurality of pixel periods. Optionally, the common drive waveforms may be periodic and may comprise cycles of pixel periods whereby the cycles are repeated for the duration of the common drive waveform. This repeating nature means that the same trimmed drive waveform can be used for that actuator and need only to synchronise with the repeating period of the common drive waveforms in order to cause the transition to occur at the same time in each cycle. Similarly, the relative difference in timing between different trimming signals for supplying bespoke control signals to two or more (or each) actuator can be maintained since they need only repeat with the same common drive waveform period and the system will remain synchronised.

Optionally, for a first period of time of the print cycle, the first common drive waveform is held at a first voltage, V₁, whereas the second common drive waveform is held at a second voltage, V₂; and subsequently for a second period of time of the print cycle, the first common waveform is held at a third voltage, V₃, whereas the second common drive waveform is held at a fourth voltage, V₄; wherein V₃ is lower than V₁ and V₄ is lower than V₂. Here lower than means “closer to a nominal baseline reference voltage” in the case that both voltages are positive (relative to some nominal baseline reference voltage, sometimes referred to herein as V₀), “negative” in the case where the two voltages are on either side of V₀, and “more negative” in cases where both voltages are negative. Typically, the voltages are ordered from highest to lowest in numerical order, i.e. V₄ is lower than V₃, which is lower than V₂, with V₁ being the highest (that is, V₄<V₃<V₂<V₁). Optionally, the first and second common drive waveforms comprise an ejection waveform component and a non-ejection waveform component; and wherein the waveform select causes a transition between the ejection waveform component of the first common drive waveform and the non-ejection waveform component of the second common drive waveform, in response to the trimming signal; and/or the waveform select causes a transition between the ejection waveform component of the second common drive waveform and the non-ejection waveform component of the first common drive waveform, in response to the trimming signal. As an example, a non-ejection waveform component may be one which causes a deformation of the actuator, such that the deformation is not sufficient to cause ejection. By contrast an ejection waveform component is one that not only causes a deformation of the actuator but also is sufficient to eject a droplet. An ejection waveform component is usually one which has greater magnitude (i.e. is further from a nominal baseline, V₀) than a non-ejection waveform component. A transition between ejection and non-ejection waveform components provides a trimmed output with the amount of trimming being controlled by the timing of the transition.

Optionally, the first common drive waveform is an ejection waveform and the second common drive waveform is a non-ejection waveform; and the waveform select causes a transition between the ejection waveform and the non-ejection waveform, in response to the trimming signal. The maximum amplitude of the first and second common drive waveforms may differ, and in that the first common drive waveform has a larger amplitude than the second common drive waveform.

Optionally, the trimming signal causes a transition from the first common drive waveform to the second common drive waveform during the first period of the print cycle. Optionally, the trimming signal is a first trimming signal. Further, there may be a second trimming signal which may cause a transition from the second common drive waveform to the first common drive waveform during the second period of the print cycle. Further optionally, there may be a third trimming signal which may cause a transition from the first common drive waveform to the second common drive waveform during the third period of the print cycle. Even further, there may be a fourth trimming signal which may cause a transition from the first common drive waveform to the second common drive waveform during the fourth period of the print cycle. Providing two or more trims on the waveform provides more flexibility in tailoring the drive waveform supplied to the actuator to compensate the specific variations in ejection properties of a given fluid chamber. However, it should be noted that the trimming may be applied only to the first period of the print cycle. Also, depending on the requirement, only one trimming signal may be applied in one of the periods.

Each common drive waveform may be periodic with a period T. In some cases, additional flexibility may be provided by providing a trimming signal which causes different output from the circuit to be applied to the actuator(s) in each period T by changing the time at which the transition occurs between the two or more common drive waveforms within each periodic repetition. In other words, the trimming signal may update or change in each repetition.

Optionally, the circuit further comprises a further input for receiving a third common drive waveform; and wherein the waveform select is further configured to couple the third common drive waveform to a second output which is connected to a second electrode of the actuator. This can allow for a predetermined signal to be applied to the second electrode. For example, the two electrodes may be located at either side of a planar piezoelectric element. By providing a known signal to the second electrode, a certain amount of deformation in the piezoelectric material can be provided as standard. This provides a known background against which the first electrode can cause its own deformations. For example, the first electrode can either reinforce or partially cancel out the deformations provided by the third common drive waveform applied to the second electrode, thereby opening up further nuance in the trimming options available.

In yet further examples, the circuit further comprises another further input for receiving a fourth common drive waveform; and wherein the waveform select is further configured to couple the third or the fourth common drive waveform to a second output, which is connected to a second electrode of the actuator; and in response to a third trimming signal, cause a transition between the third and fourth common drive waveforms. With such a configuration, both the first and second electrodes may be supplied with trimmed drive signals, thereby allowing yet more flexibility in the available trimming options. In some cases, the third common drive waveform is an inverted form of the first common drive waveform and/or wherein the fourth common drive waveform is an inverted form of the second common drive waveform. This can lead to a simpler system since each waveform may be related to other waveforms by simple transformations (reflection in this case). In some cases, such as this, the second common drive waveform may be provided by directly inverting the first common drive waveform, rather than expressly providing a separate second waveform.

In any example described herein where the waveform select receives more than two inputs and/or outputs more than one output, this may be understood as a single waveform select with three or more inputs and/or two or more outputs. Alternatively, this may be provided as several waveform selects, collectively having the total number of inputs and outputs to provide the required arrangement. In some cases, this may mean that not all couplings to the actuators are provided by waveform selects. In the example above where there are only three common drive waveforms, for example, a waveform select may be provided to handle transitions between the first and second common drive waveforms, but the coupling of the third common drive waveform to the second electrode does not necessarily require a waveform select and may instead be provided by simply connecting the third common drive waveform to the second electrode via a drive circuit.

The common drive waveforms may start and/or finish at a reference voltage level. This level may be the value referred to above as V₀, for example, and provides a useful reference point for the signals.

Optionally, two or more common drive waveforms each may have a positive component and a negative component relative to the reference voltage level; and wherein: the positive component of the first common drive waveform has a higher amplitude than the amplitude of the positive component of the second common drive waveform; and/or the positive component of the third common drive waveform has a higher amplitude than the amplitude of the positive component of the fourth common drive waveform; and/or the negative component of the first common drive waveform has a lower amplitude than the amplitude of the negative component of the second common drive waveform; and/or the negative component of the third common drive waveform has a lower amplitude than the amplitude of the negative component of the fourth common drive waveform. These forms of waveform provide a convenient set of options for transitioning from one common drive waveform to another and to accordingly provide a trimmed output for supplying to the actuator. Here, lower amplitude of a negative component means that it has a smaller absolute magnitude, consistent with discussions elsewhere in this document.

The circuits described above may be provided in combination with a droplet ejection head, which comprises a plurality of actuators, each actuator being associated with at least one fluid chamber.

Also disclosed herein is a droplet ejection apparatus comprising one or more droplet ejection heads wherein each droplet ejection head comprising a plurality of actuators, each actuator associated with at least one fluid chamber, and a circuit for controlling a plurality of actuators, the circuit comprising: inputs for receiving a first common drive waveform, a second common drive waveform, and a trimming signal; an output for supplying an individual drive waveform to an actuator; and a waveform select configured to couple to the first common drive waveform and to the output for connection to a first electrode of the actuator; the waveform select is configured to provide the individual drive waveform to a selected one of the actuators based on the first common drive waveform, the second common drive waveform and the trimming signal; wherein the waveform select is further configured to, cause a transition from the first common drive waveform to the second common drive waveform by decoupling the first common drive waveform from the output and coupling the second common drive waveform to the output, the transition occurring at a time determined by the trimming signal.

The droplet ejection apparatus may further comprise an ejection signal input for receiving information designating each actuator as an ejecting chamber or a non-ejecting chamber for each print cycle.

Optionally, the fluid chambers with which actuators are associated may be arranged in three groups, designated as A, B, and C, such that any set of three adjacent fluid chambers includes at least one each of A, B and C fluid chambers; and wherein the fluid chambers may be arranged in a repeating pattern of actuators belonging to each of the three groups arranged in the same order to form the repeating pattern. Optionally, each time period of length T in the print cycle may have three sub-cycles designated as an A sub-cycle, a B sub-cycle and a C sub-cycle. The fluid chambers having a designation which does not match the sub-cycle designation may be designated as inactive fluid chambers while the fluid chambers having a designation matching with the sub-cycle designation are assigned as active fluid chambers. Furthermore, the fluid chambers having a designation matching with the sub-cycle designation are further assigned as active ejecting or active non-ejecting fluid chambers in accordance with the print signal. This allows for a multi-cycle ejection in which the fluid chambers are arranged such that adjacent fluid chambers do not eject simultaneously, which can reduce crosstalk. Note that this specific example relates to three-cycle ejection, but other examples may have two, or any number greater than three cycles within the general principles set out herein.

Optionally, the actuators associated with inactive fluid chambers may be provided with a common inactive waveform while the actuators associated with active non-ejecting fluid chambers may be provided with a common active non-ejecting waveform. Further, the waveform select may be configured to receive a bespoke trimming signal input for each active ejecting fluid chamber to control transitions between the first common drive waveform and the second common drive waveform and to output a bespoke drive waveform supplied to actuators associated with each active ejecting fluid chamber. This ensures that only fluid chambers which are intended to eject at a given time are provided with an appropriately trimmed actuation signal.

Optionally, the waveform select comprises a switching circuit configured to provide the transition from the first common drive waveform to the second common drive waveform.

Optionally, the waveform select comprises at least two switching circuits controlled by a switch control and configured to provide the transition from the first common drive waveform to the second common drive waveform.

Optionally, the ejection apparatus further comprises a timing circuit configured to control the transition from the first common drive waveform to the second common drive waveform, the transition occurring at a time determined by the trimming signal.

The or each switching circuit may further comprise a high resistance path and a low resistance path; wherein the high resistance path is configured to enable the transition from the first common drive waveform to the second common drive waveform.

In another example, the fluid chambers may be designated as active fluid chamber and inactive fluid chamber in an alternating manner. The waveform select may be configured to receive a bespoke trimming signal input for each active ejecting fluid chamber to control transitions between the first and second common drive waveforms and to output a bespoke drive waveform supplied to actuators associated with each active ejecting fluid chamber. In other words, in this example, each active fluid chamber may be directly adjacent to (or sandwiched between) two inactive fluid chambers and each inactive fluid chamber may be directly adjacent to (or sandwiched between) two active fluid chambers (except for fluid chambers at either end of the row which are adjacent to only one fluid chamber of the other type). This is another way to ensure that a fluid chamber which is due to eject droplets is never directly adjacent to another fluid chamber which is due to eject droplets, thereby reducing crosstalk.

Optionally, the waveform select may be configured to cause one or more further transitions between the first and second common drive waveforms. This may occur in either direction, i.e. the transition may be from the first common drive waveform to the second common drive waveform, or from the second common drive waveform to the first common drive waveform, as applicable and as required, and allows for more flexibility in how trimming is implemented.

Optionally, a timing circuit may be configured to output a trimming signal at a draw, release or reinforce section of the common drive waveform. As noted above, these phases are:
Draw phase: A phase in which the fluid chamber volume increases to draw in additional fluid.
Release phase: A phase in which the fluid chamber volume decreases from its volume at the end of the draw phase. This begins the process of releasing a droplet (also referred to generally herein as ejecting a droplet).
Reinforce phase: A phase in which the fluid chamber volume continues to decrease after the end of the release phase to reinforce the release of the droplet.

Following the reinforce phase, a cancellation phase is usually applied, which is a final change in volume to return to the fluid chamber volume corresponding to that at which the draw phase began, thereby allowing the process to repeat in these four phases. In other words, a print cycle for a single fluid chamber includes the draw-release-reinforce-cancel phases in that order. The cancel phase may also be trimmed in some examples.

In some cases, the common drive waveform may have only draw and release phases, in which case the release phase may be halted at the point where the volume of the fluid chamber has returned to that at which the draw phase began.

As described above, the volume of the fluid chamber is altered by supplying drive waveform to the actuator. These drive waveforms may be trimmed (i.e. by transitioning between common drive waveforms) during at least one of the phases discussed above to ensure that each fluid chamber ejects droplet/s in the desired manner, for example, each fluid chamber has substantially uniform droplet ejection characteristics.

Optionally, the droplet ejection apparatus further comprises a further input for receiving a third common drive waveform; and wherein the waveform select is further configured to couple the third common drive waveform to a second electrode of the actuator. Optionally, the droplet ejection apparatus further comprises another further input for receiving a fourth common drive waveform; and wherein the waveform select is further configured to couple the third or the fourth common drive waveform to a second electrode of the actuator in accordance with a third trimming signal. As discussed above, this may provide additional flexibility in tailoring the drive waveform to the characteristics of a given fluid chamber or a given actuator.

In cases described generally herein, where two drive signals are supplied to different electrodes associated with a single actuator various possibilities exist. In order of increasing complexity, a selection of options can be:
1. The same trimming signal may be used to generate the output supplied to each electrode, meaning that the transition between common drive waveforms occurs at the same time on both electrodes.
2. Two separate trimming signals may be used to generate different, independent, outputs for each electrode, leading to transitions between common drive waveforms which may occur at different times for the two electrodes.
3. A single trimming signal which has timings encoded for different transition times on each electrode.
4. A single trimming signal having sufficient information carrying capacity to encode multiple transitions at different times, on each electrode.

Optionally, the third common drive waveform is an inverted form of the first common drive waveform and/or the fourth common drive waveform is an inverted form of the second common drive waveform.

Optionally, the common drive waveforms each have a positive component and a negative component relative to a reference voltage; and wherein: the positive component of the first common drive waveform has a higher amplitude than the amplitude of the positive component of the second common drive waveform; and/or the positive component of the third common drive waveform has a higher amplitude than the amplitude of the positive component of the fourth common drive waveform; and/or the negative component of the first common drive waveform has a lower amplitude than the amplitude of the negative component of the second common drive waveform; and/or the negative component of the third common drive waveform has a lower amplitude than the amplitude of the negative component of the fourth common drive waveform. These forms of waveform provide a convenient set of options for transitioning between waveforms, to provide a trimmed output for supplying to the actuator. Here, lower amplitude of a negative component means that it has a smaller absolute magnitude, consistent with discussions elsewhere in this document.

The droplet ejection apparatus may further include a signal generator coupled to the inputs to supply the common drive waveforms. This provides a complete system able to generate and provide the common drive waveforms as well as bespoke trimmed drive signals to the actuator. Optionally, the signal generator is located off-head and the waveform select is located on-head. This allows for the maximum amount of the circuitry as possible to be shifted away from the droplet ejection head, so that heat generation can be minimised on the droplet ejection head. Here off-head means remote from the droplet ejection head, while on-head means located at or adjacent to the droplet ejection head. In some cases, on-head components may be formed integrally with the droplet ejection head.

Also disclosed herein are corresponding methods to the circuits and apparatuses described above, from which similar benefits may be derived from corresponding features. These methods include a method of controlling a plurality of actuators, each actuator associated with at least one fluid chamber in a droplet ejection apparatus, the method comprising: receiving first and second common drive waveforms; receiving a trimming signal; and outputting an individual drive waveform during an print cycle by: coupling the first common drive waveform to a first electrode of a first actuator; in response to the trimming signal, decoupling the first common drive waveform from the first electrode of the first actuator; and coupling the second common drive waveform to the first electrode of the first actuator, the transition occurring at a time determined by the trimming signal.

Optionally, receiving a trimming signal includes receiving a plurality of different trimming signals; and each of the plurality of different trimming signals may be used to generate, for different actuators, a different output drive waveform as required, in which a transition between the common drive waveforms may occur at different times.

Optionally, a bespoke trimming signal is received for each actuator to provide a bespoke drive waveform for each actuator, in which a transition between the common drive waveforms occurs at bespoke times for each actuator.

Optionally, the method further comprises empirically determining the optimal trimming signal for the or each actuator. Optionally, the method further comprises updating the trimming signal iteratively.

Optionally, the common drive waveforms are periodic and repeat for each iteration of the print cycle. In other words, the method can be executed repeatedly to eject additional sets of droplets. The time between equivalent parts of the method is T, and the waveforms may also have a repetition period of T.

Optionally, for a first period of time of the print cycle, the first common drive waveform is held at a first voltage, V₁, and the second common drive waveform is held at a second voltage, V₂; and subsequently for a second period of time of the print cycle, the first common drive waveform is held at a third voltage, V₃, and the second common drive waveform is held at a fourth voltage, V₄; wherein V₃ is lower than V₁ and V₄ is lower than V₂.

Optionally, the first and second common drive waveforms comprise an ejection waveform component and non-ejection waveform component; and wherein the individual drive waveform is provided by a transition between the ejection waveform component of the first common drive waveform and the non-ejection waveform component of the second common drive waveform, in response to the trimming signal; and/or the individual drive waveform is provided by a transition between the ejection waveform component of the second common drive waveform and the non-ejection waveform component of the first common drive waveform, in response to the trimming signal.

Optionally, the first common drive waveform is an ejection waveform and the second common drive waveform is a non-ejection waveform; and the actuator waveform is provided by a transition between the ejection waveform and the non-ejection waveform, in response to the trimming signal.

Optionally, the trimming signal causes a transition from the first common drive waveform to the second common drive waveform during the first period of print cycle.

Optionally, the trimming signal is a first trimming signal. Further, there may be a second trimming signal which causes a further transition from the second common drive waveform to the first common drive waveform during the second period of print cycle. Additionally or alternatively, the trimming signal may cause a transition from the second common drive waveform to the first common drive waveform during the first period wherein the trimming signal may be a first trimming signal. Furthermore, a second trimming signal may cause a further transition from the first common drive waveform to the second common drive waveform during the second period of the print cycle.

Optionally, each common drive waveform is periodic with period T.

Optionally, the method further comprises receiving a third common drive waveform and coupling the third common drive waveform to a second electrode of the actuator.

Optionally, the method further comprises receiving a fourth common drive waveform and a third trimming signal; and coupling a second drive waveform to the second electrode of the actuator. The second drive waveform being provided by a transition between the third common drive waveform and the fourth common drive waveform at a time determined by the third trimming signal. Optionally, the third common drive waveform is an inverted form of the first common drive waveform and/or wherein the fourth common drive waveform is an inverted form of the second common drive waveform.

Optionally, the common drive waveforms start and/or finish at a reference voltage level. Optionally, the common drive waveforms each have a positive component and a negative component relative to the reference voltage level; and wherein: the positive component of the first common drive waveform has a higher amplitude than the amplitude of the positive component of the second common drive waveform; and/or the positive component of the third common drive waveform has a higher amplitude than the amplitude of the positive component of the fourth common drive waveform; and/or the negative component of the first common drive waveform has a lower amplitude than the amplitude of the negative component of the second common drive waveform; and/or the negative component of the third common drive waveform has a lower amplitude than the amplitude of the negative component of the fourth common drive waveform.

Optionally, the drive waveform(s) is/are supplied to a plurality of actuators, each actuator being associated with at least one fluid chamber, and wherein the method further comprises: receiving a drive waveform designating each actuator as an ejecting fluid chamber or as a non-ejecting fluid chamber for each print cycle.

Optionally, the fluid chambers with which each actuator is associated are arranged in three groups, designated as A, B, and C, such that any set of three adjacent fluid chambers includes at least one each of A, B and C fluid chambers; and wherein the fluid chambers are arranged in a repeating pattern of actuators belonging to each of the three groups arranged in the same order to form the repeating pattern.

Optionally, each time period of length T has three sub-cycles designated as an A sub-cycle, a B sub-cycle and a C sub-cycle in which fluid chambers having a designation which does not match the sub-cycle designation may be assigned as inactive fluid chambers and in which only fluid chambers having a designation matching the sub-cycle designation may be assigned as active fluid chambers; and wherein fluid chambers having a designation matching the sub-cycle designation may further be assigned as active ejecting or active non-ejecting fluid chambers in accordance with the drive waveform.

Optionally, a common inactive waveform is supplied to actuators associated with inactive fluid chambers; a common active non-ejecting waveform is supplied to actuators associated with active non-ejecting fluid chambers; and a bespoke trimming signal is received for each active ejecting fluid chamber to control transitions between the first and second common drive waveforms thereby to output a bespoke active ejecting waveform for each active ejecting fluid chamber.

Optionally, the fluid chambers are permanently designated as active and inactive fluid chambers in an alternating manner; and wherein a bespoke trimming signal is received for each active ejecting fluid chamber to control transitions between the first and second common drive waveforms thereby to output a bespoke active ejecting waveform for each active ejecting fluid chamber.

Optionally, the method further comprises one or more further transitions between the first and second common drive waveforms. Optionally, the timing at which the trimming signal causes a, the, or each transition between common drive waveforms is at a draw, release or reinforce section of the common drive waveform.

Optionally, the method further comprises receiving a third common drive waveform; and wherein coupling the third common drive waveform to a second electrode of the actuator.

Optionally, the method further comprises receiving a fourth common drive waveform and a third trimming signal; and coupling a drive waveform to the second electrode, the drive waveform being provided by a transition between the third common drive waveform and the fourth common drive waveform at a time determined by the third trimming signal.

Optionally, the third common drive waveform is an inverted form of the first common drive waveform and/or wherein the fourth common drive waveform is an inverted form of the second common drive waveform.

Optionally, the common drive waveforms each have a positive component and a negative component relative to a reference voltage; and wherein: the positive component of the first common drive waveform has a higher amplitude than the amplitude of the positive component of the second common drive waveform; and/or the positive component of the third common drive waveform has a higher amplitude than the amplitude of the positive component of the fourth common drive waveform; and/or the negative component of the first common drive waveform has a lower amplitude than the amplitude of the negative component of the second common drive waveform; and/or the negative component of the third common drive waveform has a lower amplitude than the amplitude of the negative component of the fourth common drive waveform.

Optionally, a signal generator for supplying the common drive waveforms is located off-head and the coupling and decoupling operations of waveform are performed on-head.

### BRIEF DESCRIPTION OF THE FIGURES

Embodiments of the invention will now be described, by way of example only, and with reference to the drawings in which:

FIG. 1 shows waveform select connections to actuators according to a first example;

FIG. 2 shows examples of four common drive waveforms used in the example shown in FIG. 1 to provide a trimmed output applied to electrodes controlling a fluid chamber wall;

FIG. 3 shows a trimmed drive waveform applied to a first electrode 131b of the example shown in FIG. 1;

FIG. 4 shows a trimmed drive waveform applied to a second electrode 131a of the example shown in FIG. 1;

FIG. 5 shows a schematic of a circuit for implementing the methods disclosed herein;

FIG. 6 shows a block diagram of two drive circuits to actuators according to a variation of the first example;

FIG. 6A shows an example of an arrangement of a switching circuit in a waveform select of FIG. 6;

FIG. 7 shows a schematic of electrical connections to electrodes on actuator walls separating fluid chambers in a second example;

FIG. 8 shows a resultant voltage applied across the first actuator wall according to the second example.

FIG. 9 shows a block diagram of a drive circuit for each fluid chamber and the corresponding connections to actuators according to a third example;

FIG. 9A shows an example of an arrangement of a switching circuit in a waveform select of FIG. 9;

FIG. 10 shows examples of common active ON drive waveforms for use in active ON fluid chambers of the third example;

FIG. 11 shows an example of a common inactive drive waveform for use in inactive fluid chambers of the third example;

FIG. 12 shows an example of a common active OFF drive waveform suitable for applying to an active OFF fluid chamber in the third example;

FIGS. 13 and 14 show respectively a schematic and an equivalent circuit diagram of a compound passgate with either a high internal resistance or a low internal resistance;

FIG. 15 shows an example of a trimmed active ON drive waveform supplied by a timed transition between the waveforms in FIG. 10, for supplying to the electrodes of active ON actuators;

FIG. 16 shows examples of trimmed active ON drive waveforms formed using different trimming options, and based on the waveforms in FIG. 9;

FIG. 17 shows an alternating array of active and inactive fluid chambers and associated electrode connections for use in a fourth example;

FIG. 18 shows examples of common active ON drive waveforms for use in active ON fluid chambers in the fourth example;

FIG. 19 shows examples of trimmed active ON drive waveforms applied to active ON actuators and formed using different trimming options, and based on the waveforms in FIG. 18;

FIG. 20 shows examples of common drive waveforms for use in providing trimmed signals for active fluid chambers in a fifth example;

FIG. 21 shows a trimmed active ON waveform applied to active ON fluid chambers in the fifth example;

FIG. 22 shows an example inactive actuator waveform applied to an inactive fluid chamber neighbouring an active ON fluid chamber in the fifth example;

FIG. 23 shows an example active OFF actuator waveform applied to an active OFF fluid chamber in the fifth example;

FIG. 24 shows an example inactive actuator waveform applied to an inactive fluid chamber neighbouring an active OFF fluid chamber in the fifth example;

FIG. 25 shows an example of a difference of potential waveform applied across individual actuator walls of active ON fluid chambers in the fifth example;

FIG. 26 shows an example of a difference of potential waveform applied across individual actuator walls of active OFF fluid chambers in the fifth example;

FIG. 27 shows a droplet ejection head of the fifth example with the ejection of five droplets;

FIG. 28 shows the waveforms applied to the electrodes in the fifth example to cause the ejections shown in FIG. 26;

FIG. 29 shows a set of trimming options to provide flexibility in tailoring the actuator signal;

FIG. 30 shows an example of common drive waveforms having an ejection waveform and a non-ejection waveform and an example of a trimmed drive waveform having four transitions between common drive waveforms.

### DETAILED DESCRIPTION

The present embodiments represent some examples of putting the invention into practice. However, they are not the only ways in which this can be achieved. It will be apparent, for example, that there are many options for timing of even a single transition between common drive waveforms to provide a trimming signal to an actuator. When multiple transitions are considered, the number of options increases even further. Below are presented several examples to illustrate the various uses of these, but the skilled person will recognise that embodiments set out herein are a subset of the general concepts which fall within the scope of the appended claims. In particular, aspects from one example below may readily be combined with other examples. To give a further specific example, where the specific examples below show a trim occurring one way around (i.e. switching from a first common drive waveform to a second common drive waveform at a particular time), the disclosure is to be interpreted as also covering a similar transition the other way, i.e. switching from that second common drive waveform to the first common drive waveform at a similar time (similar here is used to indicate that the transition can be thought of as occurring in the same portion of the waveform, if not necessarily at the exact same time). The presently described embodiments relate to control of droplet ejection apparatus to provide consistent droplet ejection while reducing heat generation at or near the droplet ejection head. This is generally achieved by providing at least two common drive waveforms and a waveform select, arranged to selectively couple one or other of the two common drive waveforms to an actuator. The timing of the transition(s) between the common drive waveforms leads to a different output signal and is known as trimming.

Droplet ejection apparatuses may have multiple actuators and each actuator may be associated with at least one fluid chamber. Each actuator may comprise an actuator wall sandwiched between two electrodes. The systems and methods discussed here facilitate a way to provide different outputs (i.e. waveforms which have been trimmed in different ways) as required to different electrodes of the actuators. In some cases, the system may be capable of supplying a different waveforms to each electrode, so that each electrode receives a bespoke trimmed drive waveform produced by a transition between two or more common drive waveforms at a time specific to that actuator. This bespoke trimmed drive waveform controls the droplet ejection and provide consistent ejection across a number of chambers. As noted above, the optimum trimming for a given actuator/chamber may be identified empirically, by calculation, by an iterative investigative procedure, and so forth.

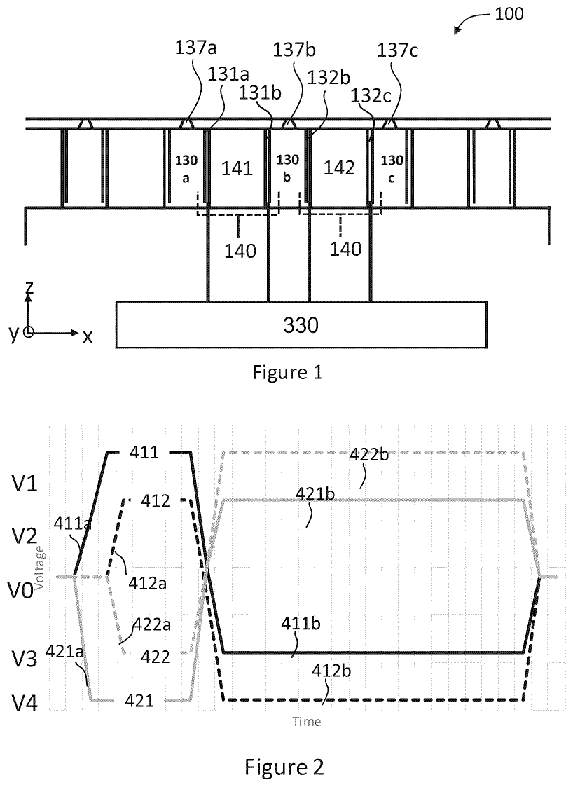

FIGS. 1 to 4 illustrate various aspects of a first example. In FIG. 1, waveform select 330 connections to two actuators 140 are shown. The droplet ejection head 100 includes a plurality of fluid chambers 130a-130c. Each of the fluid chambers is provided with a nozzle 137a-137c, from which fluid contained within the fluid chamber may be ejected. Each of the fluid chambers is elongate in a chamber length direction perpendicular to the array direction x. Adjacent fluid chambers within the array are separated by actuator walls 141, 142 or actuators 140, which may be formed of a piezoelectric material such as lead zirconate titanate (PZT), or similar materials, which are deformable upon application of potential difference across them. One longitudinal side of each of the fluid chambers 130a-130c is bounded (at least in part) by a nozzle plate, which provides a nozzle 137a-137c for each of the fluid chambers 130a-130c. Each chamber actuator wall 141, 142 is sandwiched between electrodes 131a and 131b, 132b and 132c. Electrodes 131a and 131b, 132b and 132c are configured to apply an individual drive waveform to the actuator walls 141, 142.

A waveform select 330 is connected to the electrodes 131a, 131b, 132b, and 132c of the actuator walls 141 and 142. In this example, the waveform select 330 selects between two common drive waveforms 411, 412 or 421, 422 to be applied across each actuator wall 141 and 142: common drive waveform 411 and common drive waveform 412 are applied to the first electrode 131b and common drive waveform 421 and common drive waveform 422 are applied to the second electrode 131a in the manner discussed below in more detail. FIG. 2 shows examples of these four common drive waveforms 411, 412, 421, and 422 to be applied by the waveform select 330 to the first and second electrodes 131b and 131a. Here it can be seen that the common drive waveforms each have a first pulse and a second pulse. Further, each of the common drive waveforms begins and ends at a baseline voltage V0 and increases in magnitude (some part of the waveform increases in a positive direction and some part of the waveform increases in a negative direction so magnitude should be interpreted as referring to |V−V0|) up to an initial maximum magnitude for that common drive waveform. This initial maximum value is held for the first portion of the common drive waveform. At the end of the first portion, the common drive waveforms each transition to the second portion. Here common drive waveforms which were initially negative (with respect to V0) pass V0 and become positive, and vice versa. Each common drive waveform moves to a new magnitude and holds it for the duration of the second portion. At the end of the second portion, each common drive waveform returns to V0, for example to allow the print cycle to repeat.

In the example shown, the first pulse 411a of the common drive waveform 411 has an initial maximum amplitude of V1 and the second pulse 411b has a maximum amplitude of V3. Similarly, the first pulse 412a of the common drive waveform 412 has an initial maximum amplitude of V2 and the second pulse 412b has a maximum amplitude of V4. Further, it can be seen that the first pulse 421a of the common drive waveform 421 has an initial maximum amplitude of V4 and the second pulse 421b has a maximum amplitude of V2. Finally, the first pulse 422a of the common drive waveform 422 has an initial maximum amplitude of V3 and the second pulse 422b has a maximum amplitude of V1. In each case V1> V2>V0>V3>V4, that is V1 and V2 are positive with respect to a reference voltage V0, and V1 is higher than V2. Similarly, V3 and V4 are negative with respect to the reference voltage V0, and V4 is lower than V3.

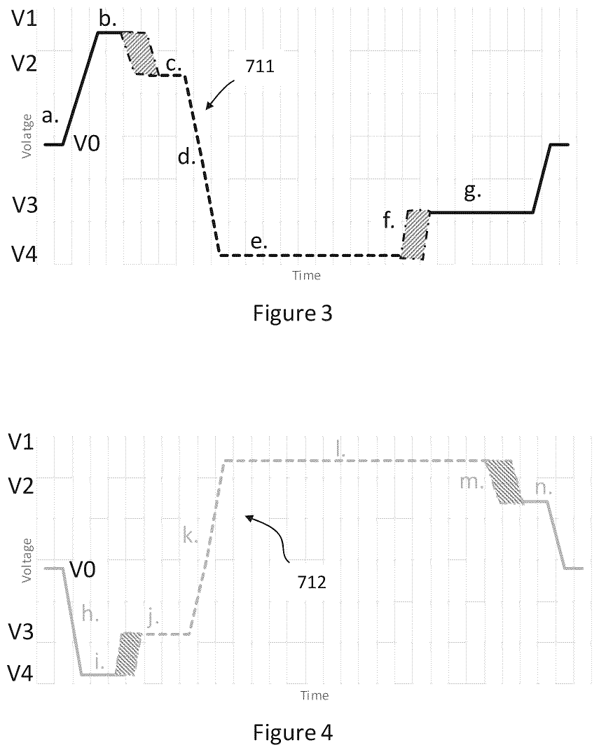

In this example, to eject a droplet, the following procedure and waveforms shown in FIGS. 3 and 4 are enacted.

An illustration of the resultant trimmed drive waveform 711 applied to the first electrode 131b is shown in FIG. 3. First, (FIG. 3, step a) for the individual or trimmed drive waveform 711, the waveform select 330, selects the common drive waveform 411 to be applied to electrode 131b. In step b of FIG. 3, the trimmed drive waveform 711 follows the common drive waveform 411 and the voltage of the trimmed drive waveform 711 increases from baseline voltage V0 to a maximum voltage V1.

Next (FIG. 3, step c), while the common drive waveform 411 is at V1, waveform select 330 switches from selecting and applying the common drive waveform 411 to selecting and applying the common drive waveform 412 to the first electrode 131b. As a result, the voltage applied to the first electrode 131b decreases from V1 (which is carried by the common drive waveform 411) to V2 (which is carried by the common drive waveform 412) and stays at V2 for some time. The switch timing is not fixed and can be adjusted as shown by the hashed area which indicates the different amount of trimming which may be applied. This effectively generates a ledge or shoulder (between steps b and c in FIG. 3) on the waveform applied to the actuator and it can be adjusted to adapt the required ejection parameters to achieve a desired effect. If no trimming is required, the trimmed drive waveform 711 will just follow the common drive waveform 412.

Then at step d of FIG. 3, the trimmed drive waveform follows the common drive waveform 412 and the voltage of trimmed drive waveform is decreased from V2 to V4 (as the second pulse 412b of the common drive waveform-see FIG. 2). At this stage, the droplet is ejected from nozzle 137b. Note here that in order to eject a droplet from the nozzle 137b, a voltage for e.g. zero volts or reference voltage V0 or a waveform such as 712 of FIG. 4, may be applied to the other electrode 132b. Alternatively, the other electrode 132b may be considered held by waveform select 330 at a fixed voltage relative to the first electrode 131b.

At step e of FIG. 3, the trimmed drive waveform 711 holds voltage at V4. While the voltage of the trimmed drive waveform 711 is at V4, the waveform select 330 switches from selecting and applying the common drive waveform 412 back to selecting and applying the common drive waveform 411 to the first electrode 131b and as per the trimming requirement, effectively generating a ledge on the trimmed drive waveform1.

As a result, the voltage applied to the first electrode 131b increases from V4 (carried by the common drive waveform 412) to V3 (carried by the common drive waveform 411) and stays at V3 for some time. The switch timing is not fixed and can be adjusted and this is shown by the hashed area to provide further trimming options (FIG. 3, step g). If no trimming is required, the trimmed drive waveform 711 just follows the common drive waveform 411.

Finally, the voltage of the trimmed drive waveform 711 stays at V3 for some time before raising to V0 again. In this way, the trimmed drive waveform can be generated in this example using common drive waveforms 411 and 412.

In the above example, only the hashed areas are generated on-head which allows for the location of heat generation to be moved away from the droplet ejection head and, in particular, allows for as little as possible of the heat to be generated on the head by shifting the complexity of producing the two waveforms off-head. The only fluid chamber-specific transition which occurs on-head is a switch between the two common drive waveforms at a time determined by the trimming signal.

FIG. 4 shows an example of a trimmed drive waveform 712 that can be applied to the second electrode 131a. In essence, this waveform 712 is the inverse of the trimmed drive waveform 711 shown in FIG. 3, i.e. the same trimmed drive waveform 711, but reflected along the V0 axis so as to vary a potential difference between the first and second electrodes 131b, 131a such that the corresponding chamber wall deforms to cause the ejection of a droplet from the nozzle. It can be seen that the common drive waveform 421 and the common drive waveform 422 shown in FIG. 2, are inverted versions of the common drive waveform 411 and the common drive waveform 412 and indeed these common drive waveforms are used to generate the trimmed drive waveform 712 applied to the second electrode 131a.

In other words, as shown in FIG. 4, the waveform select 330 switches between selecting and applying the common drive waveform 421 and the common drive waveform 422 to the second electrode 131a in the following way.

First, as shown in FIG. 4, step h, for the trimmed drive waveform 712, the common drive waveform 421 is selected and applied to the second electrode 131a. In this step, the trimmed drive waveform 712 follows the common drive waveform 421 and the voltage of the trimmed drive waveform 712 decreases from V0 to V4. At step I of FIG. 4, the trimmed drive waveform 712 holds the voltage at V4 which is the maximum voltage of the common drive waveform 421.

Next (FIG. 4, step j), while the trimmed drive waveform 712 is at V4, the waveform select 330 switches from selecting and applying the common drive waveform 421 to selecting and applying the common drive waveform 422 to the second electrode 131a, effectively generating a ledge on the trimmed drive waveform 712 applied to the second electrode 131a. As a result, the voltage applied to the second electrode 131a increases from V4 (carried by the common drive waveform 421) to V3 (carried by the common drive waveform 422) and stays at V3 for some time. The switch timing is not fixed and can be adjusted and this is shown by the hashed area which indicates the different amount of trimming which may be applied. This effectively generates a ledge or shoulder (between steps i and j in FIG. 4) on the trimmed drive waveform 712 applied to the second electrode 131a which can be adjusted to adapt the required ejection parameters to achieve a desired effect.

Next at step k of FIG. 4, the trimmed drive waveform 712 follows the common drive waveform 422 and the voltage increases from V3 to V1 (the second pulse 422b of the common drive waveform 422 as shown in FIG. 2).

At step I of FIG. 4, the trimmed drive waveform 712 holds voltage V1 for some time. Then at step m of FIG. 4, while the trimmed drive waveform 712 is at voltage V1, the waveform select 330 switches from selecting and applying the common drive waveform 422 back to selecting and applying the common drive waveform 421 to the second electrode 131a, effectively generating a ledge on the trimmed drive waveform 712 applied to the second electrode 131a. In this step, the voltage applied to the second electrode 131a decreases from V1 (carried by the common drive waveform 422) to V2 (carried by the common drive waveform 421) and stays at V2 for some time. The switch timing is not fixed and can be adjusted depending on the trimming requirement and this is shown by the hashed area.

Finally at step n of FIG. 4, the trimmed drive waveform 712 stays at V2 for some time before decreasing to V0 again. Consequently, so does the voltage applied to the second electrode 131a.

Of course, the above arrangement is merely an example. For example, if a single actuator wall of the chamber imparts enough energy to eject a droplet through a nozzle, the second actuator wall of the chamber may have no potential difference applied across it and, therefore, no actuator wall movement is observed.

If both actuator walls of the chamber are necessary to eject a droplet through a nozzle, both actuator walls will have to have some potential difference applied across them. However, this does not mean the waveforms applied to both actuator walls have to be trimmed: the waveforms could be both trimmed, either trimmed or no trimming applied.

It is also possible that only one transition between two waveforms can be used to trim the output signal. In other case, if two transitions are made: V3=V4, for the chamber's first actuator wall and/or V1=V2, for the chamber's second actuator wall or vice-versa.

Hot switching is observed in the transitions between the common drive waveform 411 and the common drive waveform 412, and between the common drive waveform 421 and the common drive waveform 422 (hashed areas in FIG. 3 and FIG. 4), while cold switching is observed in all transitions within each common drive waveform (the common drive waveform 411, the common drive waveform 412, the common drive waveform 421, and the common drive waveform 422), since these changes are provided as part of the common drive waveforms themselves.

In steps c., f., j. and m., controlling the switching time back and forth between the common drive waveforms 411, 412 and the common drive waveforms 421, 422 allows control over the shape of the trimmed drive waveform 711, 712 applied to the first and second electrodes 131b, 131a which in turn is applied to actuator wall 141, and consequently, controls the velocity and/or volume of the droplet ejected by the nozzle 137a, 137b. It should be noted that, as mentioned earlier, in order to eject a droplet from the nozzle, a voltage for e.g. zero volts or reference voltage V0 or a waveform such as 712 of FIG. 4, may be applied to the other electrode. Alternatively, the other electrode may be considered held by waveform select 330 at a fixed voltage relative to the electrode 131b, 131a.

The trimmed drive waveform applied to eject a droplet from one fluid chamber can be adjusted over time to compensate for temperature changes and/or piezoelectric material ageing in the actuator walls. In addition, based on the same common drive waveforms, two different actuator walls can have different shaped trimmed drive waveforms with a larger or smaller ledges, allowing the volume and/or velocity of the droplets ejected between two nozzles to be made uniform.

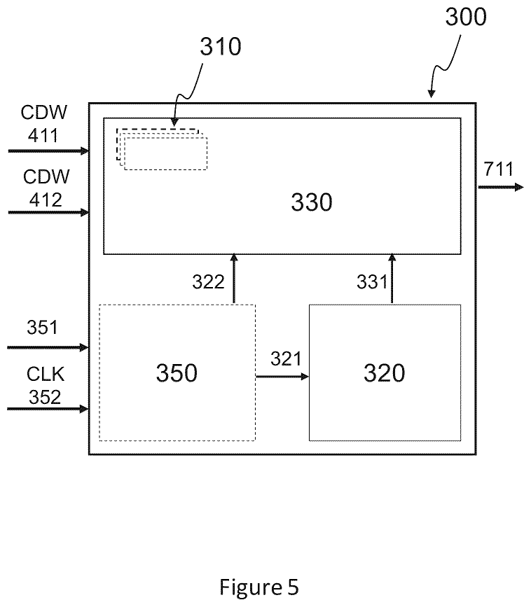

FIG. 5 shows another example of a drive circuit 300 that provides trimmed drive waveform to at least one electrode such that a corresponding fluid chamber ejects a droplet via a corresponding nozzle. The drive circuit 300 has at least one waveform select 330 which is configured to receive a first common drive waveform (CDW) 411, a second common drive waveform (CDW) 412, a print signal 322, and a switching timing 331. The waveform select 330 is configured to output the selected common drive waveform. Further, the waveform select is configured to switch between selecting and applying the first common drive waveform 411 to selecting and applying the second common drive waveform 412 based on the switching timing 331, and effectively coupling the at least one electrode 131b to a trimmed drive waveform 711 that may be formed partially by the first common drive waveform 411 and partially by the second common drive waveform 412. The print signal 322 is configured to indicate whether a dot is to be printed for a particular pixel by a particular nozzle. For example, when no dot is to be printed for a particular pixel, the waveform select 330 can decouple the electrode 131b from the first and second common drive waveforms 411, 412 for the duration of the print cycle so that no drive waveform is produced for a given pixel of an image. Each waveform select 330 may include at least two switching circuits 310a, 310b that switch between two or more common drive waveforms. It should be noted that the switching circuit may be a part of the waveform select or may be a separate circuit in which case, the waveform select may receive and send signals to switching circuit.

Further, the drive circuit 300 may include a timing circuit 320 that may generate the switching timing 331 upon receiving a trimming signal 321. The trimming signal 321 indicates the amount of trimming required by a particular actuator. There can be many ways in which the timing circuit 320 can generate switching timing 331 to control the switching between first and second common drive waveforms 411, 412. For example, the switching timing 331 can be synchronised with an internal clock or to a level of the common drive waveforms or to some other timing reference.

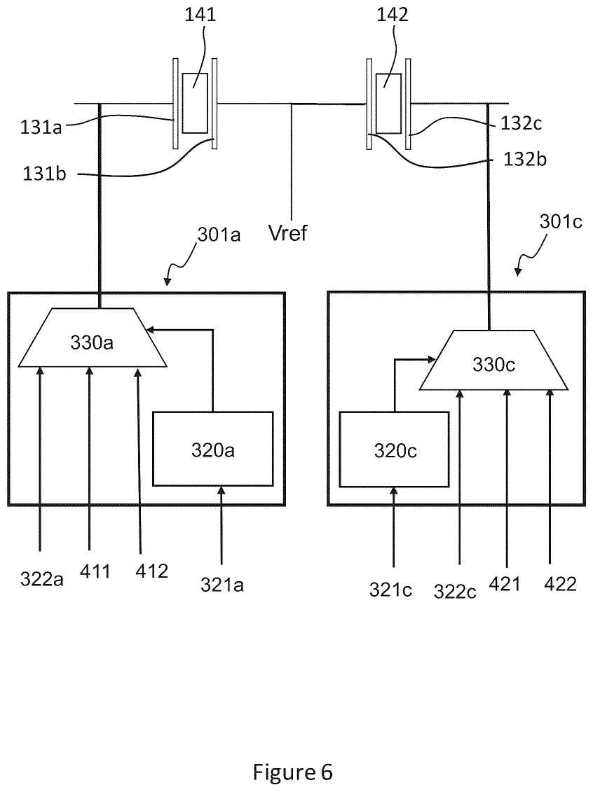

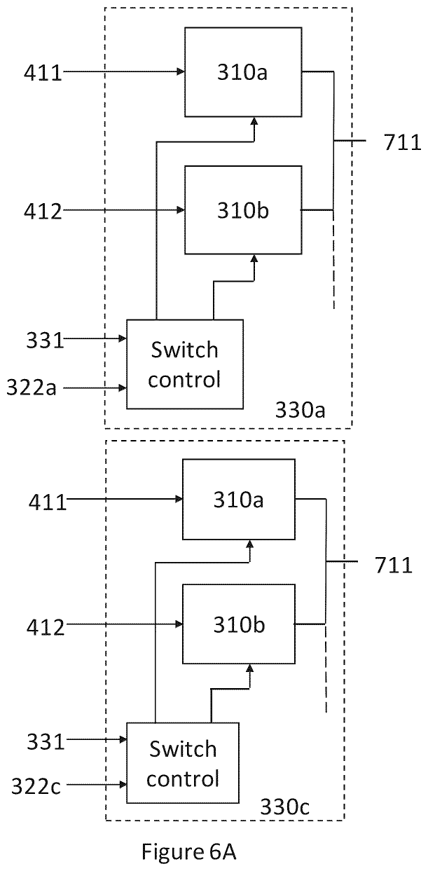

The drive circuit 300 may further include a controller 350 which may be configured to derive the print signal 322 and the trimming signal 321 from a data signal 351 and a clock signal (CLK) 352. In another example, each actuator wall may have one electrode electrically connected to a common signal. FIG. 6 shows the electrodes 131b and 132b connected to a common signal, Vref. This common signal may be constant signal or time varying depending on the desired voltage profile with time measured across each actuator wall. On the other hand, the electrodes 131a and 132c may be supplied with trimmed drive waveforms like the ones depicted in FIGS. 3 and 4. This means that, instead of selecting and applying the common drive waveforms across the walls, the waveform select, in a drive circuit, may select and apply common drive waveforms 411 and 412 or 421 and 422 to the electrodes 131a and 132c, respectively. Therefore, the waveform applied across each actuator wall may be the waveform output by waveform select minus this common signal.

FIG. 6 shows another example of two drive circuits 301a and 301c, each comprising the following elements:
a waveform select 330a, 330c which are configured to select between at least two common drive waveforms (CDW) 411 and 412 or 421 and 422 based on a print signal 322a, 322c and a trimming signal 321a, 321c, and is configured to couple one or more electrodes 131a, 132c to the selected common drive waveform (CDW) 411 and 412 or 421 and 422 selected by the waveform select 330;
a timing circuit 320a, 320c for controlling the waveform select 330a, 330c.

The waveform select 330a, 330c each may comprise a switching circuit 310a, 310b. Each switching circuit 310a, 310b may receive a common drive waveform 411, 412 at its input. The switching circuits 310a, 310b may be controlled by a switch control based on print signal 322a, 322c and a switching timing signal 331. FIG. 6A shows an example of an arrangement of a switching circuit in a waveform select of FIG. 6.

The timing circuit 320a, 320c is configured to receive a trimming signal 322a, 322c. The timing circuit 320a, 320c is configured to control the time at which the waveform select 330a, 330c transitions between a first common drive waveform and a second common drive waveform to implement the trimming.

Accordingly, the waveform select 330a, 330c applies a trimmed drive waveform which may be formed by a part of the first common drive waveform and a part of the second common drive waveform, to the respective electrode 131a, 132c, as above. The print signal 322a, 322c is configured to indicate whether a dot is to be printed for a particular pixel by a particular nozzle. For example, if no ejection is required, no signal may be sent. In other cases, non-ejection may nevertheless result in a waveform being sent, e.g. to cancel the induced actuator wall motion from an ejecting adjacent fluid chamber or to maintain a degree of fluid motion to ensure that the downtime of the chamber does not allow the fluid to block the nozzle of the fluid chamber due to being inactive for too long.

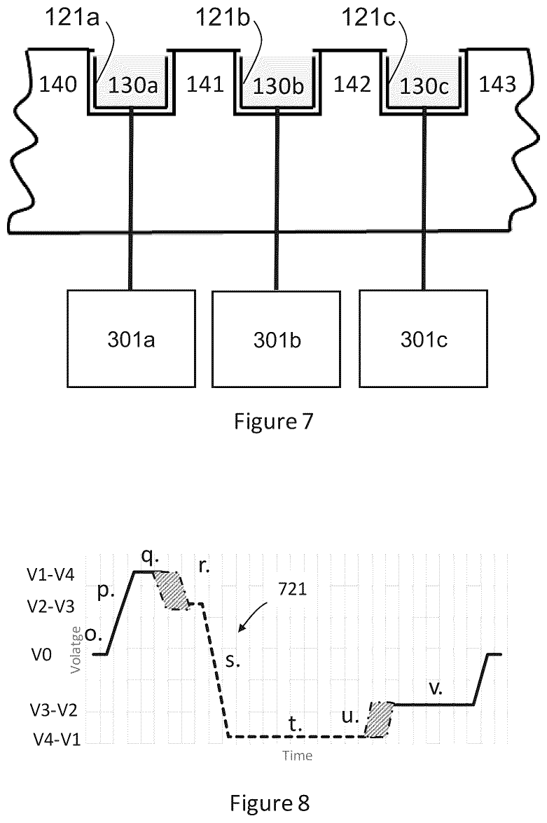

Now moving on to FIGS. 7 and 8 which depict a second example. FIG. 7 shows a schematic of electrical connections to electrodes 121a to 121c on the actuator walls 140 to 143. The fluid chambers 130a to 130c are separated by the actuator walls 140 to 143. Each fluid chamber 130a to 130c has a single electrode 121a to 121c disposed along a respective fluid chamber 130a to 130c. It should be noted that this electrode configuration is by no means necessary for the application of the waveforms disclosed herein because individually addressable electrodes on each actuator wall (as shown in FIG. 1) can achieve the same effect if the appropriate changes in the electronics that applies the waveforms are made.

The common drive waveforms 411, 412, 421, 422 of FIG. 2 can be applied to the electrodes 121a to 121c associated with the actuators 130a, 130b and 130c but their application has to be adjusted. Here, to deform the chamber wall so as to cause the ejection of a droplet from the nozzle, instead of applying the common drive waveforms 411, 412, 421, 422 to two separate electrodes, the common drive waveforms 411, 412, 421, 422 are applied to the continuous electrodes 121a, 121b and 121c.

FIG. 8 illustrates an example of a resultant voltage 721 applied across the first actuator wall 141 to eject a droplet from the fluid chamber 130a, 130b. Firstly, in step o, at some point during V0 holding period, a drive circuit 301b couples the common drive waveform 411 to the electrode 121b, while drive circuit 301c couples the common drive waveform 421 to electrode 121c.

At some point, the voltage of common drive waveform 411 increases from V0 to V1 and remains at V1 while the voltage of common drive waveform 421 decreases from V0 to V4 and remains at V4 such that the voltage across the first actuator wall 141 increases from V0 to V1-V4 and remains at V1-V4 as shown in steps p and q of FIG. 8. Next (FIG. 8, step r), during the holding periods of both common drive waveforms 411 and 421, the drive circuit 301b switches from applying the common drive waveform 411 to applying the common drive waveform 412 while the drive circuit 301a switches from applying the common drive waveform 421 to applying the common drive waveform 422.

As a result, the voltage across the first actuator wall 141 decreases from applying V1−V4 to V2−V3 and remains at V2−V3 for some time. The switch timing is not fixed and can be adjusted and this is shown by the hashed area which indicates the different amount of trimming which may be applied. This effectively generates a ledge or shoulder on the waveform applied to the actuator which can be adjusted to adapt the required ejection parameters to achieve a desired effect.

Then the voltage of the common drive waveform 412 decreases to V4, while the voltage of the common drive waveform 422 increases to V1, so the voltage across the first actuator wall 141 is V4−V1 and remains at the new potential difference for some time (steps s and t of FIG. 8). Next, as shown in step u of FIG. 8, during the holding periods of both the common drive waveforms 412 and 422, the drive circuit 301b switches from applying the common drive waveform 412 to applying the common drive waveform 411 while the drive circuit 301a switches from applying the common drive waveform 422 to applying the common drive waveform 421.

As a result, the potential difference applied across the first actuator wall 141 of fluid chamber 130a, 130b decreases from V4−V1 to V3−V2 and remains at this difference of potential for a period of time. The switch timing is not fixed and can be adjusted and this is shown by the hashed area to provide further trimming options (FIG. 8, step u). Finally, the common drive waveform 411 increase from V3 to V0 while the common drive waveform 421 decreases from V2 to V0 such that the voltage across the first actuator wall 141 decreases from V3−V2 to V0.

At this point, one should note that the trimmed drive waveform applied to the electrode 121c may be an inverted form of the trimmed drive waveform applied to the electrode 121b. Further, the common drive waveforms applied by the drive circuit 301c to the electrode 121c are the same common drive waveforms applied to the electrode 121a.

A further example can be observed by modifying the number of common drive waveforms input into each waveform select. For example, it is possible to apply traditional 3-cycle waveforms with trimming. In such examples, the fluid chambers with which each actuator is associated are arranged in three groups, designated as A, B, and C, such that any set of three adjacent fluid chambers include at least one each of A, B and C fluid chambers. The fluid chambers are arranged in a repeating pattern of actuators belonging to each of the three groups arranged in the same order to form the repeating pattern, for example . . . ABCABC . . . and so forth.

In addition, each print cycle has three sub-cycles designated as an A sub-cycle, a B sub-cycle and a C sub-cycle. In each sub-cycle, fluid chambers having a designation which does not match the sub-cycle designation are designated as inactive fluid chambers. Only fluid chambers having a designation matching the sub-cycle designation are assigned as active fluid chambers. In other words, ‘A’ fluid chambers can only possibly eject droplets on an ‘A’ sub-cycle, and similarly for ‘B’ and ‘C’ fluid chambers/sub-cycles. Fluid chambers having a designation matching the sub-cycle designation are further assigned as either active ejecting or active non-ejecting fluid chambers in accordance with the ejection signal i.e. even active fluid chambers do not always eject droplets, but only eject based on a print signal (or ejection signal) which indicates whether an ejection is wanted during that sub-cycle.

This 3-Cycle printing mode traditionally requires at least three common drive waveforms to be applied in turns to the actuators:
Active ON waveform-Waveform applied to an active ejecting fluid chamber and eject a droplet from the corresponding nozzle in a given sub-cycle;
Active OFF waveform-Waveform applied to an active non-ejecting fluid chamber which, consequently, does not eject a droplet from the corresponding nozzle in a given sub-cycle, and
Inactive-Waveform applied to an inactive fluid chamber, which cannot eject within a given sub-cycle.

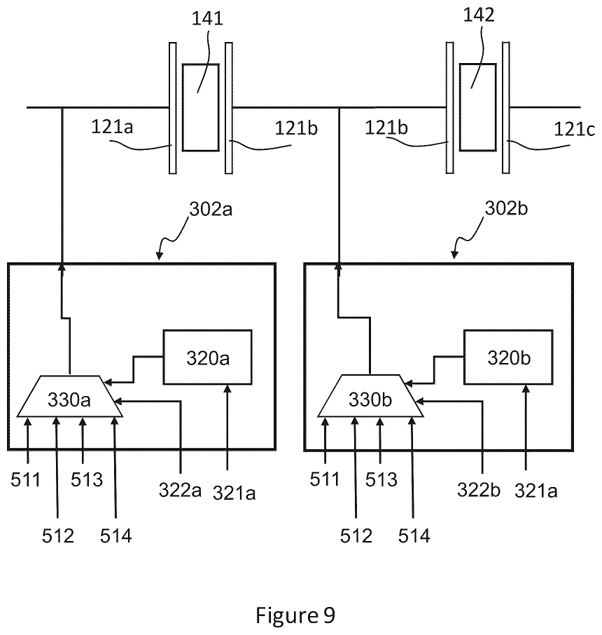

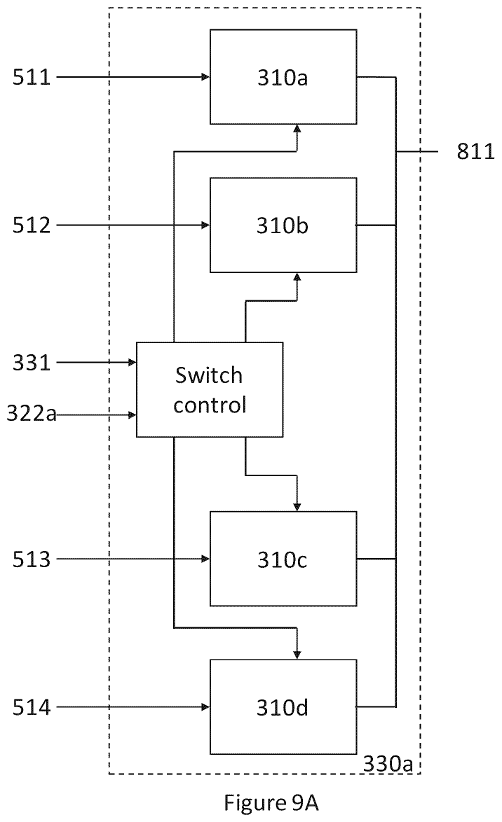

In FIG. 9, a block diagram is shown of two drive circuits 302a and 302b and the corresponding connections to electrodes of an actuator wall 141 according to the example shown in FIG. 7. Each drive circuit 302a, 302b has a timing circuit 320a, 320b. Each drive circuit 302a, 302b of FIG. 9 also includes a waveform select 330a, 330b configured to select between at least four common drive waveforms to be applied to each electrode 121a, 121b or 121c. In this example, the timing circuit 320a, 320b is configured to control the timing at which the waveform select 330a, 330b selects one of the common drive waveforms (CDW) 511 to 514 and outputs said common drive waveform (CDW) to the respective electrodes 121a, 121b, 121c of the fluid chamber 130a, 130b.

The waveform select 330a, 330b, each may comprise a switching circuits 310a, 310b, 310c, 310d. Each switching circuit 310a, 310b, 310c, 310d may receive a common drive waveform 511, 512, 513, 514 at its input. The switching circuits 310a-310d may be controlled by a switch control based on the print signal 322a and a switching timing signal 331. FIG. 9A shows an example of an arrangement of a switching circuit in a waveform select of FIG. 9.

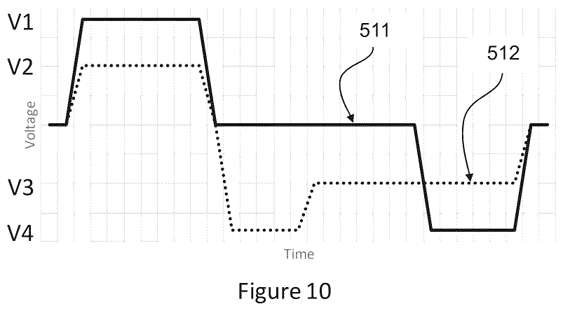

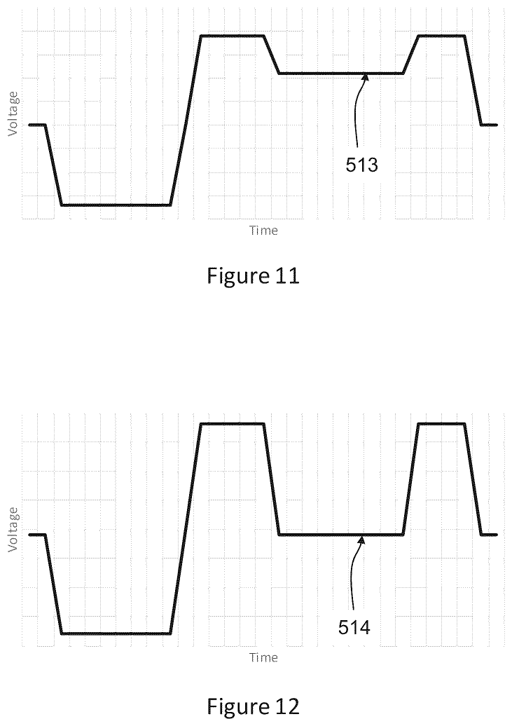

In this example, to trim in a similar manner as described above, at least four common drive waveforms input into each waveform select 330a, 330b are used: one common inactive waveform 513 shown in FIG. 11; one common active OFF waveform 514 shown in FIG. 12; and two common active ON waveforms 511 and 512 shown in FIG. 10. Alternatively, in this example, to trim in the above described manner, at least three common drive waveforms input into each waveform select 330a, 330b are used such that common inactive waveform 513 may not be required, and common active OFF waveform 514 may function as common inactive waveform as required.

In each case, based on a print signal 322a, 322b and a signal from the timing circuit 320a, 320b, the waveform select 330a, 330b selects and outputs one of the common drive waveforms to the respective electrodes of the fluid chamber 130a, 130b.

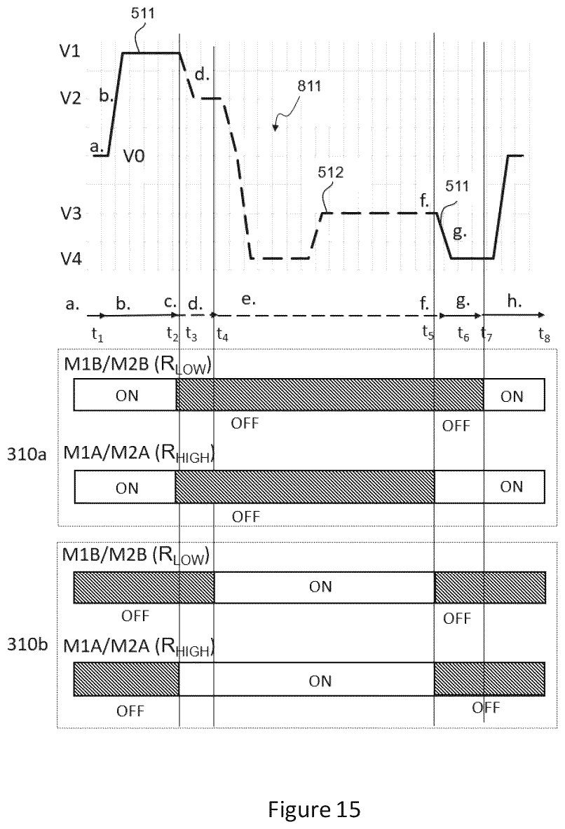

In addition, examples of the common active ON drive waveforms for use in this example are shown in FIG. 10. FIG. 11 shows an example of a common inactive drive waveform for use in inactive fluid chambers. FIG. 12 shows an example of a common active OFF drive waveform for use in active OFF fluid chambers. FIG. 15 shows an example of a trimmed drive waveform 811 depicted with a timed transition between the common drive waveforms in FIG. 10, for supplying to the electrodes of active ON actuators.

Assuming that nozzle 137b of fluid chamber 130b is desired to eject during its sub-cycle, the following process is followed. The common drive waveforms applied to the electrode 121a of fluid chamber 130a and to the electrode 121c of fluid chamber 130c are common inactive drive waveforms 514 like the one shown in FIG. 11, since the only active fluid chambers during the sub-cycle are the ones of the same sub-cycle as fluid chamber 130b and directly adjacent actuators must be part of a different sub-cycle by virtue of the assignment of sub-cycles discussed above. To trim, the waveform select 330b selects and applies one of the two common active ON drive waveforms 511, 512 to the electrode 121b of fluid chamber 130b based on the signals output by the timing circuit 320b. Also, during the sub-cycle and based on the signals output by the timing circuit 320b, the waveform select 330b switches from selecting and applying one common active ON drive waveform to selecting and applying the other common active ON drive waveform to the electrode 121b of the fluid chamber 130b.

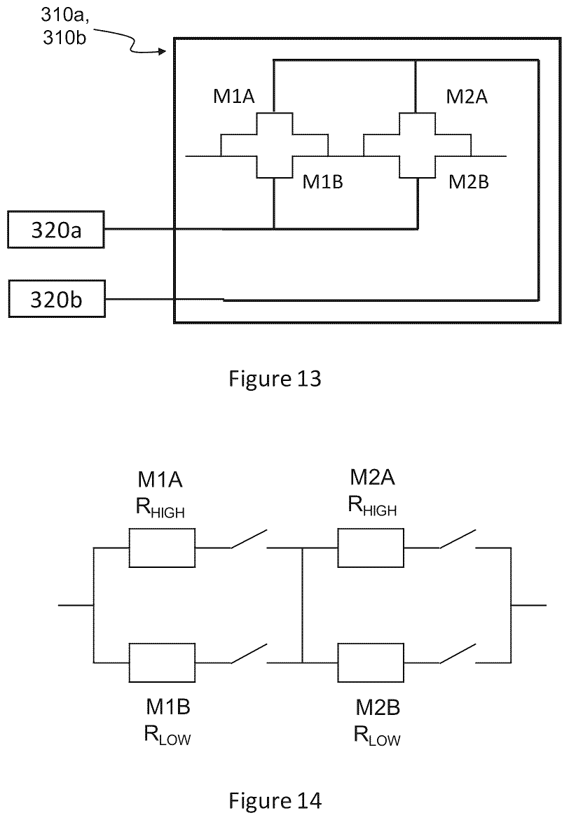

FIG. 13 shows an example of a switching circuit 310a, 310b depicted in FIG. 5 and contained in the waveform select 330, where the switching circuits 310a, 310b can each be seen as a compound passgate that comprises four transistors connected in a particular arrangement. FIG. 14 shows a simplification of the internal resistances of each transistor depicted in FIG. 13. M1B and M2B have a large Width/Length (W/L) ratio, designed to give LOW ON resistance, while M1A and M2A have a small W/L ratio designed to give a HIGH ON resistance which will reduce the slew rate of the transition between waveforms. M1B and M2B may be controlled from one timing circuit 320a, and M1A and M2A may be controlled from an independent second timing circuit 320b.

As shown in FIG. 15, during cold switching, M1B/M2B and M1A/M2A are ON. This means that the total resistance is of the compound passgate and is approximately 2R_{Low}:
R_{COLD}=R_{M1A}//R_{M1B}+R_{M2B}//R_{M2A}, where the internal resistance of M1A is in parallel to internal resistance of M1B and the internal resistance of M2B is in parallel to internal resistance of M2A.

$${R}_{L O W} // {R}_{HIGH} \approx {R}_{LOW} , and {R}_{COLD} = {R}_{L O W} + {R}_{L O W} \approx 2 {R}_{L O W}$$

During hot switching, M1B and M2B are OFF, while M1A/M2A are ON, so the total resistance of the compound passgate is approximately 2R_{HIGH}:

$${R}_{HOT} = {R}_{M 1 A} + {R}_{M 2 A} = {R}_{HIGH} + {R}_{HIGH} \approx 2 {R}_{HIGH} .$$

The switching circuit 310a, 310b comprises a high resistance path that is used during hot switching and a low resistance path that is during cold switching, wherein the high resistance path is configured to enable the transition from the first common drive waveform to the second common drive waveform. The timing circuit 320a, 320b is configured to control the switching of the high resistance path and the low resistance path.

The low resistance of the passgates is to minimise power dissipation while the high resistance of the passgates is to minimise the peak current flow in the passgates. For example, during cold switching, the current is determined principally by the slew rate of the drive waveform and the load capacitance of the actuator, so the smaller the resistance, the lower the power dissipation. During hot switching, the peak current is determined by the switch resistance and the voltage difference between the two waveform sources at the time of switching, so a higher resistance is preferred in order to limit peak current flow.

The procedure for generating the trimmed drive waveform 811 that may be applied to one of the active ON fluid chamber in their sub-cycle through the switching circuits 310a, 310b of waveform select 330 is shown in FIG. 15. These switching circuits 310a, 310b may make use of the compound passgate shown in FIG. 13, for example. As described below, this type of switching circuit may be employed, but this is by no means limited and in other examples more basic switching circuits may be used.

At t₁ (step a), during a V0 holding period, the transistor pairs M1B/M2B and M1A/M2A of switching circuit 310a are turned ON and common active ON drive waveform 511 is applied to the electrode 121b of fluid chamber 130b. While M1B/M2B and M1A/M2A are turned ON, between t₁ and t₂ (step b), the trimmed drive waveform 811 applied to electrode 121b of fluid chamber 130b follows common active ON drive waveform 511, and the voltage is increased from V0 to V1 and then the voltage is held at V1.

At around t₂ (step c), the transistor pair M1B/M2B and M1A/M2A of switching circuit 310a is turned OFF in preparation for the switch between common active ON drive waveform 511 and common active ON drive waveform 512. The transistor pair M1A/M2A of switching circuit 310b is then turned ON so that the waveform select 330b starts outputting common active ON drive waveform 512, which is output through the high resistance transistors M1A/M2A of the switching circuit 310b to the electrode 121b of the fluid chamber 130b. This causes the resistance of the overall switch to increase, protecting the circuit against high peak currents during the waveform switchover. Therefore, the trimmed drive waveform 811 applied to electrode 121b of fluid chamber 130b follows common active ON drive waveform 512, and the voltage is decreased from V1 to V2 and then the voltage is held at V2 (t₃, step d).

Between t₄ and t₅ (step e) M1B/M2B of switching circuit 310b is turned ON and M1A/M2A of switching circuit 310b remains ON, the voltage of common active ON drive waveform 512 decreases to V4 and stays at V4 for a period of time. After that it increases (i.e. becomes less negative relative to V0) to V3 and stays at V3 for a period of time. The trimmed active ON waveform 811 applied to the electrode 121b of fluid chamber 130b follows common active ON drive waveform 512.

At around t₅ (step f), the M1B/M2B and M1A/M2A of switching circuit 310b are turned OFF in preparation for the switch from common active ON drive waveform 512 back to common active ON drive waveform 511. The transistor pair M1A/M2A of switching circuit 310a is then turned ON so that the waveform select starts outputting common active ON drive waveform 511, which is output through the high resistance transistors M1A/M2A of the switching circuit 310a to the electrode 121b of the fluid chamber 130b. This causes the resistance of the overall switch to increase protecting the circuit against high peak currents. Therefore, the trimmed drive waveform 811 applied to electrode 121b of fluid chamber 130b follows common active ON drive waveform 511, and the voltage is decreased to V4 and then is held at voltage V4 (t₆, step g).

Finally, between t₇ and t₈ (step h), M1B/M2B of switching circuit 310a are turned back ON and M1A/M2A remains ON, the common active ON drive waveform 511 stays at V4 for a period of time and, after that it increases to V0. The trimmed active ON waveform 811 applied to the electrode 121b of fluid chamber 130b follows common active ON drive waveform 511.

It will be appreciated that the timing of each of the switching ON and OFF of various transistor pairs allows for control over some of the timings of the transitions and in particular can alter the trimming applied to each signal.

The switching circuits 310a, 310b may switch OFF for a short time before and after the transition between common drive waveforms is performed, to ensure that when the transition between common drive waveforms does happen, no damage to the switching circuit is caused by unwanted currents passing between both switches.

For completeness, assume that nozzle 137b of fluid chamber 130b is intended not to eject during its sub-cycle. In this case, the common drive waveform applied to the electrode 121a on actuator 130a and actuator 130c continue to be common inactive drive waveform like the one shown in FIG. 11 and applied through switching circuit 310c of respective waveform select 330a and 330b, since the only active fluid chambers during the sub-cycle are the ones of the same sub-cycle as fluid chamber 130b. The common drive waveform applied to the electrode 121b on fluid chamber 130b is a common active OFF drive waveform like the one in FIG. 12 and applied through switching circuit 310d of waveform select 330b.

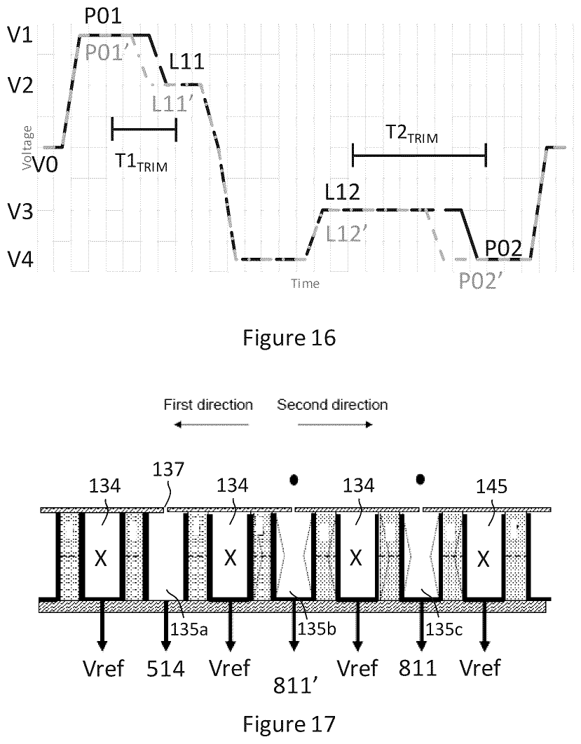

FIG. 16 shows two examples of differently trimmed active ON waveforms that may be applied to the electrode 121b of fluid chamber 130b in an ejecting fluid chamber based on the active ON common drive waveform of FIG. 10. In other words, by controlling the switching time between the common active ON drive waveform 511 and the common active ON drive waveform 512, one can effectively control the shape of the output waveform, and thereby provide an output with different trimmed drive waveforms. A later transition between the common active ON drive waveform 511 and the common active ON drive waveform 512 means a larger pulse P01 and a smaller ledge L11 (smaller T1_{TRIM}), while an earlier transition between common active ON drive waveform 511 and common active ON drive waveform 512 means a smaller pulse P01′ and a larger ledge L11′ (larger T1_{TRIM}), allowing to increase or decrease the volume/velocity of the droplet ejected by fluid chamber 130. Similar reasoning can be applied to pulses P02, P02′, ledges L12, L12′ and T2_{TRIM}. This may be thought of as the timing circuit being configured to output a trimming timing signal at a draw, release or reinforce section of the common drive waveform. Referring to FIG. 15, the draw phase is approximately steps a to c, the release phase is roughly step d and the initial part of step e, the reinforce phase is steps e to g and the first part of h. From the part of step h which begins the transition to V0 until the return to V0 is then the cancel phase.

There are many ways to generate the timing to control the duration, synchronised to an internal clock or to a level or slope of the waveforms or to some timing reference for example. To compensate for differences between actuating elements, and/or in some cases to compensate for parameters varying over time such as temperature, ageing or crosstalk from neighbouring pixels, a trimming signal is applied to switch between waveforms for each actuator effectively applying a trimmed drive waveform. The trimming signal can be generated for example from a look up table, or by a processor based on measurements of output or temperature for example, or from information such as manufacturing calibration results, or print image information for example, or a combination of these.

FIGS. 17 to 19 illustrate a third example system, in which the concept of active and inactive fluid chambers is reused. However, where in the previous example the designation as inactive was temporary for a given fluid chamber, here the designation is permanent. In some examples, for example as illustrated in FIG. 17, alternating fluid chambers 134 are blocked off and therefore cannot eject droplets. In other examples, these fluid chambers are simply not ever supplied with an ejection waveform. In any case, inactive fluid chambers 134 are arranged in an alternating fashion such that an active fluid chamber 135 is sandwiched between two inactive fluid chambers 134 and an inactive fluid chamber 134 is sandwiched between two active fluid chambers 135 (except at the ends of the array, of course, where there is only one boundary).

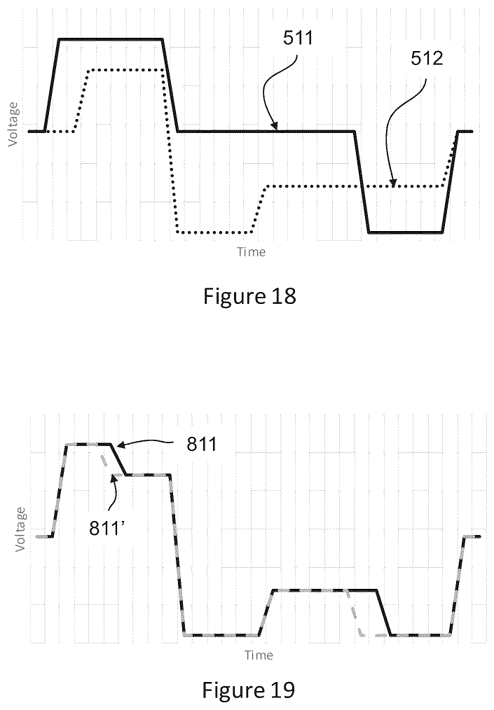

FIG. 18 shows examples of common drive waveforms for use in providing trimmed drive waveforms for the electrode of the active fluid chambers in this example. Like in the previous examples, common drive waveforms 511 and 512 are used to provide a trimmed drive waveform 811 and 811′ to be applied to an actuator by timed switching between the two common drive waveforms. The resulting trimmed drive waveform (like the ones described above) can be adjusted by changing the switching timing between common drive waveforms. In this example, each closed-off fluid chamber has its electrode connected to Vref, which can be ground, OV or some other known fixed voltage value. The non-ejecting fluid chamber of the active fluid chambers 135a receives in its electrode a common active OFF drive waveform because it is not intended to eject a droplet in this sub-cycle. The common active OFF drive waveform may be the common drive waveform 512, for example which does not have enough energy to eject a droplet. Other (i.e. different from the example of FIG. 18) common drive waveforms may be applied as common active OFF drive waveforms in other examples of course. The trimmed drive waveform applied to the electrodes on the fluid chambers 135b and 135c are 811′ and 811, respectively, as shown in FIG. 19.

In FIG. 19, examples are shown of trimmed drive waveforms formed using different trimming options based on the waveforms in FIG. 18. Here the different timings for switching in the draw and reinforce stages are shown to result in clearly different signals for supply to the electrodes of the fluid chambers.

So far, all waveforms discussed have been bipolar common drive waveforms, in which where the waveforms have at least one positive pulse and at least one negative pulse (i.e., one pulse with amplitude higher than reference voltage V0, one pulse with amplitude lower than reference voltage V0). However, it is also possible to use unipolar waveforms to control the actuator walls of the fluid chambers (i.e., waveforms where the pulses only have an amplitude larger than a reference voltage). Broadly the theory here is that, because a waveform can be applied to either side of an actuator wall, a negative pulse on one side of the actuator wall acts like a positive pulse on the other side of the actuator wall. Utilising this can lead to a simplification in signals supplied because inverting the signals is not necessary. Instead, the waveform select can be arranged to simply couple the same signal to the electrode on the opposed actuator wall surface.

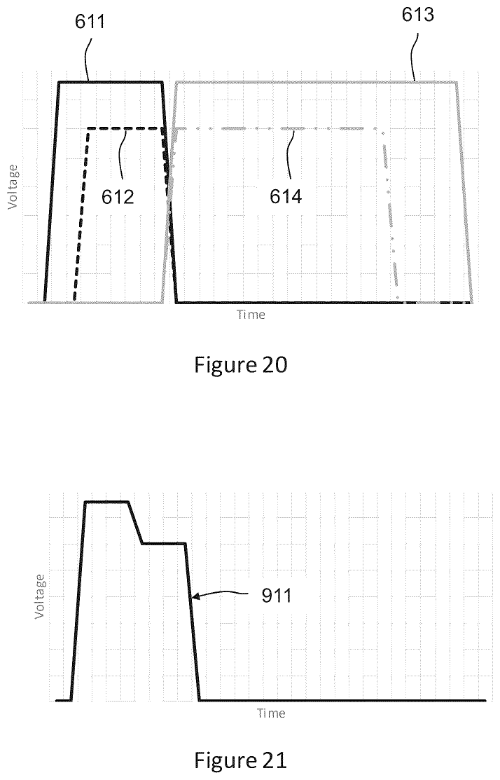

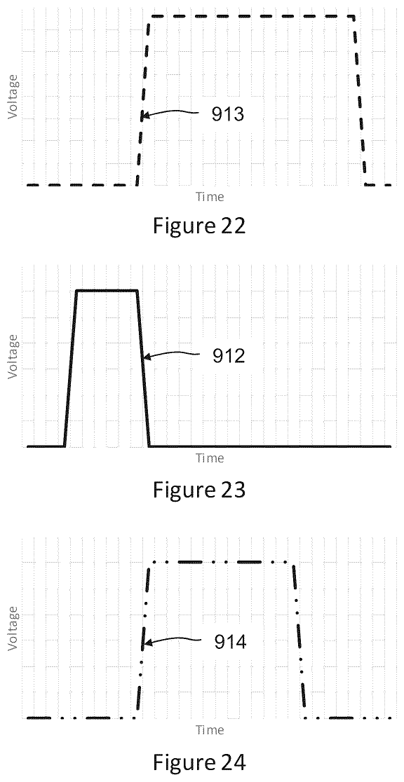

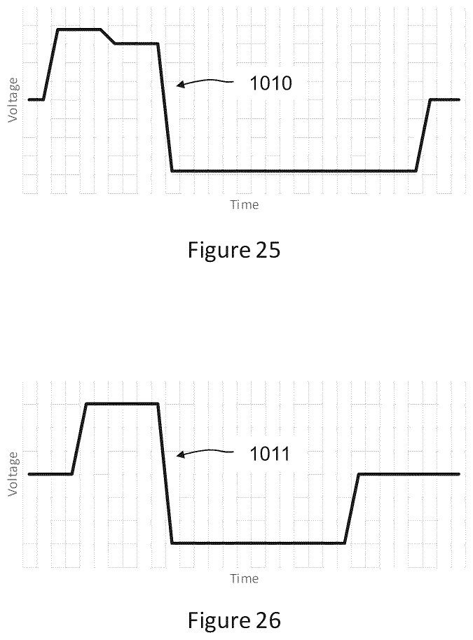

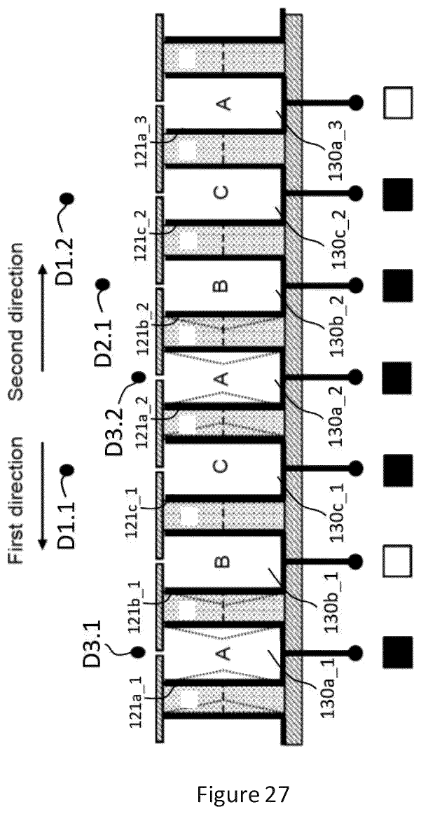

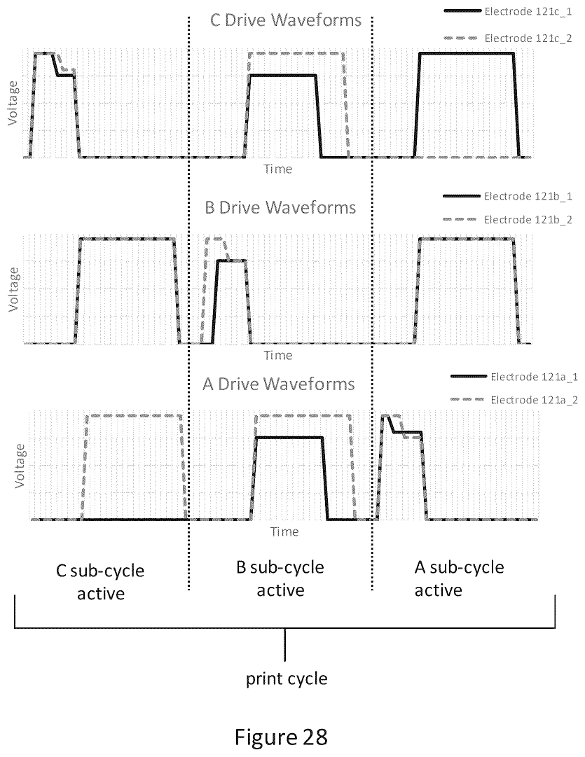

FIG. 20 shows some examples of unipolar common drive waveforms that can be applied to a 3-cycle ejecting mode actuating in a C->B->A order. In addition, FIG. 21 shows a corresponding trimmed active ON drive waveform 911, while FIG. 22 shows an example inactive drive waveform 913 applied to an inactive fluid chamber that is neighbouring an active ON fluid chamber. FIG. 23 shows an example active OFF drive waveform 912 applied to an active OFF fluid chamber and FIG. 24 shows an example inactive drive waveform 914 applied to an inactive fluid chamber that is neighbouring an active OFF fluid chamber. Finally, FIGS. 25 and 26 illustrate difference waveforms 1010, 1011 (i.e. voltage difference applied across an actuator wall) for active ON and active OFF fluid chambers, respectively. The use of these waveforms in ejecting droplets is shown in FIGS. 27 and 28, showing respectively the droplet ejection head with droplet depositions and the signals applied to various of the electrodes to achieve this.

Consider now FIG. 27, which shows a droplet ejection head actuator operating in a CBA 3-cycle and the ejection of five droplets with the pixel line to be printed. The droplet ejection head begins ejecting for a print cycle, i.e. a time period T in which each fluid chamber has the opportunity to eject a droplet, in accordance with a print signal. Here the process starts with the C sub-cycle and in particular fluid chambers 130c_1 and 130c_2 are ejecting fluid chambers (active ON) and eject droplets D1.1 and D1.2 substantially at the same time. All other fluid chambers are A and B fluid chambers so are inactive fluid chambers in this sub-cycle.

Next, the B sub-cycle operates, in which fluid chamber 130b_1 is a non-ejecting fluid chamber and therefore does not produce a droplet (designated as active OFF). By contrast, the fifth fluid chamber 130b_2 is an ejecting fluid chamber (active ON) and ejects a droplet D2.1, similar to fluid chambers 130c_1 and 130c_2 above. All other fluid chambers are A and C fluid chambers so are inactive fluid chambers in this sub-cycle.

Finally, in the A sub-cycle, fluid chambers 130a_1 and 130a_2 are ejecting fluid chambers (active ON) and eject droplets D3.1 and D3.2 substantially at the same time. Fluid chamber 130a_3 is a non-ejecting fluid chamber and therefore does not produce a droplet (active OFF). All other fluid chambers are B and C fluid chambers so are inactive fluid chambers in this sub-cycle.

It will be appreciated that the detail of the ejection/deposition procedure is analogous to the ejection/deposition procedures set out above, and therefore a detailed explanation is not repeated here.

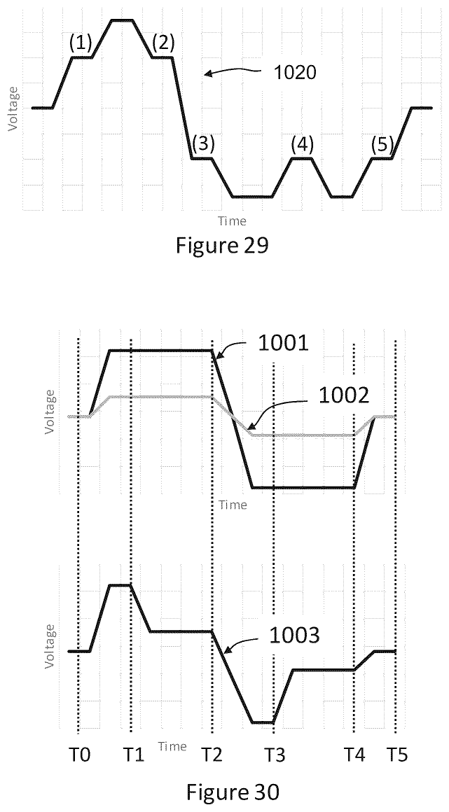

In order to achieve the deposition pattern shown in FIG. 27, the signals shown in FIG. 29 are applied to the electrodes of each fluid chamber. In particular, the total time T in which a complete print cycle is able to run (i.e., the combined time for each of the A-, B- and C-sub-cycles to run) is split into three portions, each representing (in order) the C-, B- and A-sub-cycles. The waveforms supplied to the electrodes of C fluid chambers are shown at the top, those supplied to the electrodes of B fluid chambers are in the middle row and the waveforms supplied to the electrodes of A fluid chambers are at the bottom of the Figure. It can be seen that when a fluid chamber is an inactive fluid chamber a simple trapezoidal waveform is applied to the actuator, which helps to provide a known background and reduce crosstalk in the droplet ejection head. Where a droplet ejection is required (top left corner, centre, and bottom right corner), a short, trimmed pulse is applied. Due to the unipolar nature of the system, the wide trapezoidal inactive pulses are applied to the opposed actuator wall to the active pulses, leading to a reinforce phase across the actuator walls. Active OFF pulses are provided in a similar manner but will of course be selected so that there is insufficient differential voltage across the actuator walls to trigger an ejection.

There are several options for trimming an active ON drive waveform, as discussed above. For example, trimming on the leading edge or the falling edge of each pulse. In other words, at the start of a draw phase, the end of a draw phase/start of a release phase, the start or end of a reinforce phase, etc.

FIG. 29 shows a trimmed drive waveform 1020 with some examples of trimming ledges. Like with the previous examples, by controlling the time of switch between the two or more common drive waveforms, one can control the size of the ledge.

The inventors have found some useful considerations when choosing which ledges to use on trimming.

To control the droplet velocity, trimming can be applied to the draw (1), release (2) or reinforce (3) sections of the waveform. At points (1) and (3), the high voltage waveform overshoot and ringing needs to be considered. Systems using waveform amplifiers that can shape these corners may be able to limit the overshoot and ringing sufficiently to trim effectively and consistently at these points.

For waveforms that eject a conductive fluid trimming can be applied on the reinforce (3) or cancel (5) edges. It can also be applied between the edges (4).

Applying trimming on the cancel (5) phase may limit the effectiveness of the cancel pulse leaving residual acoustic noise in the actuator. This weights against trimming this phase when other phases could lead to the same effect. In some cases, trimming this phase may be unavoidable, of course, to achieve the desired effect.

For low frequency waveforms, there is also possibility of trimming between the draw and release (similar to the effect shown at (4) in the reinforce phase).

The voltage signals can be used to amplify the effect of trimming by changing voltage of the one of the common drive waveforms during its generation.

Turning now to FIG. 30, an alternative arrangement is shown. Here the common drive waveforms are separated into an ejection waveform 1001 and a non-ejection waveform 1002. The primary difference being the amplitude of these waveforms in that the ejection waveform has sufficient amplitude to cause ejection of a droplet, while the non-ejection waveform does not have sufficient amplitude to cause the droplet ejection. The switching circuit then switches between these two common drive waveforms to provide the trimming in the manner discussed above. This may lead to the advantage that the non-ejection waveform can be coupled to electrodes either as a common reference signal or as an active OFF signal for example, safe in the knowledge that it will not lead to an ejection. This can simplify the process and apparatus for example.

FIG. 30 also shows a further example of a trimmed drive waveform 1003. Here the signal is trimmed at four points during the print cycle. In other words, the output signal begins as a first waveform, switches to a second waveform at t=T1, causing a first shoulder in the draw phase. At t=T2, a second switch occurs (for simplicity back to the first waveform, though this could be a third waveform in some cases of course). A third switch is implemented at t=T3. Again, for simplicity this is assumed to be back to the second waveform, but it could be a third or fourth waveform if desired. This causes a second ledge in the reinforce stage. A final switch is made at T4 (again, back to the first waveform, or to a second, third, fourth or fifth waveform as the case may be), to implement the cancel phase. It is apparent that there is a large amount of flexibility inherent in enacting each of these trimming steps.

In accordance with the principles set out herein the waveforms may be generated off-head (i.e., away from the droplet ejection head) to minimise on-head heating. The minimum amount of circuitry is provided on-head, for example the switching circuits and multiplexers for each controlled output.

1. A circuit for controlling a plurality of actuators, each actuator associated with at least one fluid chamber in a droplet ejection apparatus, the circuit comprising:
inputs for receiving a first common drive waveform, a second common drive waveform, and a trimming signal;
an output for supplying an individual drive waveform to an actuator; and
a waveform select configured to couple to the first common drive waveform and to the output for connection to a first electrode of the actuator; the waveform select is configured to provide the individual drive waveform to a selected one of the actuators based on the first common drive waveform, the second common drive waveform and the trimming signal; wherein
the waveform select is further configured to, cause a transition from the first common drive waveform to the second common drive waveform by decoupling the first common drive waveform from the output and coupling the second common drive waveform to the output, the transition occurring at a time determined by the trimming signal.

2. The circuit according to claim 1, wherein the waveform select is further configured to receive two or more trimming signals supplied to the inputs, to thereby generate a transition between the common drive waveforms at different times such that individual drive waveforms are supplied to each of the plurality of actuators.

3. The circuit according to claim 1, wherein the waveform select is configured to receive a bespoke trimming signal for each actuator to cause a transition between common drive waveforms at a time specific to that actuator.

4. The circuit according to claim 1, wherein for a first period of the print cycle, the first common drive waveform is held at a first voltage, V₁, and the second common drive waveform is held at a second voltage, V₂; and subsequently:
for a second period of time of the print cycle, the first common drive waveform is held at a third voltage, V₃, and the second common drive waveform is held at a fourth voltage, V₄; wherein
V₃ is lower than V₁ and V₄ is lower than V₂.

5. The circuit according to claim 1, wherein
the first and second common drive waveforms include an ejection waveform component and a non-ejection waveform component; and wherein
the waveform select causes a transition between the ejection waveform component of the first common drive waveform and the non-ejection waveform component of the second common drive waveform, in response to the trimming signal; and/or
the waveform select causes a transition between the ejection waveform component of the second common drive waveform and the non-ejection waveform component of the first common drive waveform, in response to the trimming signal.

6. The circuit according to claim 1, wherein
the first common drive waveform is an ejection waveform and the second common drive waveform is a non-ejection waveform; and
the waveform select causes a transition between the ejection waveform and the non-ejection waveform, in response to the trimming signal.

7. The circuit according to claim 4, wherein the trimming signal causes a transition from the first common drive waveform to the second common drive waveform during the first period of the print cycle.

8. The circuit according to claim 4, wherein a second trimming signal causes a further transition from the second common drive waveform to the first common drive waveform during the second period of the print cycle.

9. The circuit according to claim 7, wherein the trimming signal is a first trimming signal and wherein a second trimming signal causes a further transition from the first common drive waveform to the second common drive waveform during the second period of the print cycle.

10. The circuit according to claim 1, the circuit further comprising:
a further input for receiving a third common drive waveform; and
wherein the waveform select is further configured to couple the third common drive waveform to a second output for connection to a second electrode of the actuator.

11. The circuit according to claim 10, further comprising:
another further input for receiving a fourth common drive waveform; and wherein
the waveform select is further configured to couple the third or the fourth common drive waveform to a second output for connection to the second electrode of the actuator; and in response to a third trimming signal, cause a transition between the third and fourth common drive waveforms; optionally wherein the third common drive waveform is an inverted form of the first common drive waveform and/or wherein the fourth common drive waveform is an inverted form of the second common drive waveform.

12. (canceled)

13. (canceled)

14. The circuit according to claim 1, wherein the waveform select includes a switching circuit configured to provide the transition from the first common drive waveform to the second common drive waveform; and/or
wherein the waveform select includes at least two switching circuits controlled by a switch control and configured to provide the transition from the first common drive waveform to the second common drive waveform.

15. (canceled)

16. The circuit according to claim 1, further includes a timing circuit configured to control the transition from the first common drive waveform to the second common drive waveform, the transition occurring at a time determined by the trimming signal.

17. The circuit according to claim 14, wherein the or each switching circuit further includes a high resistance path and a low resistance path; wherein the high resistance path is configured to enable the transition from the first common drive waveform to the second common drive waveform;
optionally, wherein a timing circuit is configured to control switching of a high resistance path and a low resistance path.

18. (canceled)

19. A droplet ejection head comprising a plurality of actuators, each actuator associated with at least one fluid chamber, and a circuit according to claim 1.

20. A droplet ejection apparatus comprising one or more droplet ejection heads wherein each droplet ejection head comprising a plurality of actuators, each actuator associated with at least one fluid chamber, and a circuit for controlling a plurality of actuators, the circuit comprising:
inputs for receiving a first common drive waveform, a second common drive waveform, and a trimming signal;
an output for supplying an individual drive waveform to an actuator; and
a waveform select configured to couple to the first common drive waveform and to the output for connection to a first electrode of the actuator; the waveform select is configured to provide the individual drive waveform to a selected one of the actuators based on the first common drive waveform, the second common drive waveform and the trimming signal; wherein
the waveform select is further configured to cause a transition from the first common drive waveform to the second common drive waveform by decoupling the first common drive waveform from the output and coupling the second common drive waveform to the output, the transition occurring at a time determined by the trimming signal.

21. The droplet ejection apparatus according to claim 20, further comprising: an ejection signal input for receiving information designating each actuator as an ejecting chamber or a non-ejecting chamber for each print cycle.

22. The droplet ejection apparatus according to claim 20, wherein the fluid chambers with which each actuator is associated are arranged in three groups, designated A, B, and C, such that any set of three adjacent fluid chambers includes at least one each of A, B and C fluid chambers; and wherein
the fluid chambers are arranged in a repeating pattern of actuators belonging to each of the three groups arranged in the same order to form the repeating pattern.

23. The droplet ejection apparatus according to claim 22, wherein each time period of length T has three phases designated as an A phase, a B phase and a C phase in which chambers having a designation which does not match the phase designation are designated as inactive chambers and in which only chambers having a designation matching the phase designation are assigned as active chambers; and wherein
chambers having a designation matching the phase designation are further assigned as active ejecting or active non-ejecting chambers in accordance with the ejection signal;
optionally, wherein:
actuators associated with inactive chambers are provided with a common inactive waveform;
actuators associated with active non-ejecting chambers are provided with a common active non-ejecting waveform; and
wherein the waveform select is configured to receive a bespoke trimming signal input for each active ejecting chamber to control transitions between the first and second common drive waveforms and to output a bespoke active ejecting waveform supplied to actuators associated with each active ejecting chamber.

24-28. (canceled)

29. A method of controlling a plurality of actuators, each actuator associated with at least one fluid chamber in a droplet ejection apparatus, the method comprising:
receiving first and second common drive waveforms;
receiving a trimming signal; and
outputting an individual drive waveform during a print cycle by:
coupling the first common drive waveform to a first electrode of a first actuator;
in response to the trimming signal, decoupling the first common drive waveform from the first electrode of the first actuator; and
coupling the second common drive waveform to the first electrode of the first actuator, the transition occurring at a time determined by the trimming signal.

30. (canceled)

31. (canceled)
